(19) United States
(12) Patent Application Publication
(10) Pub. No.: US 2015/0114376 A1
(43) Pub. Date: Apr. 30, 2015

(54) INTER-CYLINDER AIR-FUEL RATIO VARIATION ABNORMALITY DETECTION APPARATUS

(71) Applicant: Toyota Jidosha Kabushiki Kaisha, Toyota-shi Aichi-ken (JP)

(72) Inventors: Kenji Suzuki, Susono-shi Shizuoka-ken (JP); Yasushi Iwazaki, Ebina-shi Kanagawa-ken (JP); Hiroshi Miyamoto, Sunto-gun Shizuoka-ken (JP)

(21) Appl. No.: 14/525,926

(22) Filed: Oct. 28, 2014

(30) Foreign Application Priority Data
Oct. 29, 2013 (JP) 2013-224489
Oct. 20, 2014 (JP) 2014-213931

(51) Int. Cl. F02D 41/14

(52) U.S. Cl. CPC F02D 41/1444
USPC 123/704

(57) ABSTRACT

An apparatus according to the present invention includes a control apparatus configured to detect inter-cylinder air-fuel ratio variation abnormality based on a parameter correlated with the degree of a fluctuation in output from the air-fuel ratio sensor. The control apparatus is configured to execute a step of identifying two cylinders estimated to have a deviation of the air-fuel ratio based on an output waveform from the air-fuel ratio sensor during one engine cycle, a step of performing reducing control to reduce the deviation of the air-fuel ratio on each of the two cylinders, that is, a first cylinder and a second cylinder, to calculate first and second values of the parameter, respectively, and a step of identifying one of the two cylinders having the most significant deviation of the air-fuel ratio based on the first and second values.

### CROSS-REFERENCES TO RELATED APPLICATIONS

This application claims the benefit of Japanese Patent Application No. 2013-224489, filed Oct. 29, 2013, and No. 2014-213931, filed Oct. 20, 2014 which are hereby incorporated by reference herein in their entirety.

### BACKGROUND OF THE INVENTION

1. Field of the Invention

The present invention relates to an inter-cylinder air-fuel ratio variation abnormality detection apparatus for a multicylinder internal combustion engine, and in particular, to an apparatus that detects abnormality (imbalance abnormality) in which some cylinders have an air-fuel ratio relatively significantly deviating from the air-fuel ratio of the remaining cylinders.

2. Description of the Related Art

In general, to efficiently remove harmful exhaust components for purification using a catalyst, an internal combustion engine with an exhaust purification system utilizing the catalyst needs to control the mixing ratio between air and fuel in an air-fuel mixture combusted in the internal combustion engine, that is, the air-fuel ratio. For such control of the air-fuel ratio, an air-fuel ratio sensor is provided in an exhaust passage in the internal combustion engine to perform feedback control to make the detected air-fuel ratio equal to a predetermined air-fuel ratio.

On the other hand, a multicylinder internal combustion engine normally controls the air-fuel ratio using identical controlled variables for all cylinders. Thus, even when the air-fuel ratio control is performed, the actual air-fuel ratio may vary among the cylinders. In this case, if the variation is at a low level, the variation can be absorbed by the air-fuel ratio feedback control, and the catalyst also serves to remove harmful exhaust components for purification. Consequently, such a low-level variation is prevented from affecting exhaust emissions and from posing an obvious problem.

However, if, for example, fuel injection systems for any cylinders become defective to significantly vary the air-fuel ratio among the cylinders, the exhaust emissions disadvantageously deteriorate. Such a significant variation in air-fuel ratio as deteriorates the exhaust emissions is desirably detected as abnormality. In particular, for automotive internal combustion engines, there has been a demand to detect variation abnormality in air-fuel ratio among the cylinders in a vehicle mounted state (on board) in order to prevent a vehicle with deteriorated exhaust emissions from travelling.

### SUMMARY OF THE INVENTION

For detection of an inter-cylinder air-fuel ratio variation abnormality, a parameter correlated with the degree of a variation in the output from the air-fuel sensor may be calculated so that variation abnormality can be detected based on the calculated parameter.

Furthermore, it is desirable to identify one cylinder having an air-fuel ratio most significantly deviating from the air-fuel ratios of the remaining cylinders and which may cause variation abnormality.

For the cylinder identification, for example, Japanese Patent Laid-Open No. 2002-201984 discloses that a rich- or lean-side peak phase of varying output from the air-fuel ratio sensor is detected so that one cylinder estimated to have a deviating output value from the air-fuel ratio sensor can be identified based on the peak phase. The amount of fuel for the identified cylinder is corrected to make the air-fuel ratio uniform among the cylinders.

However, the identification based on the peak phase of the air-fuel ratio sensor output is forced to involve two cylinders because of the presence of two peak phases, the rich-side peak phase and the lean-side peak phase. Thus, identifying one cylinder is difficult.

Thus, the present invention has been developed in view of the above-described circumstances. An object of the present invention is to provide an inter-cylinder air-fuel ratio variation abnormality detection apparatus that enables one cylinder with the most significant deviation of the air-fuel ratio to be identified.

An aspect of the present invention provides an inter-cylinder air-fuel ratio variation abnormality detection apparatus including:

an air-fuel ratio sensor installed in an exhaust passage common to a plurality of cylinders in a multicylinder internal combustion engine; and

a control apparatus configured to calculate a parameter correlated with a degree of a fluctuation in an output from the air-fuel ratio sensor to detect inter-cylinder air-fuel ratio variation abnormality based on the calculated parameter,

wherein the control apparatus is configured to execute:

(A) a step of identifying two cylinders estimated to have a deviation of an air-fuel ratio based on an output waveform from the air-fuel ratio sensor during one cycle of the internal combustion engine;

(B) a step of performing reducing control to reduce the deviation of the air-fuel ratio in a first cylinder of the two cylinders;

(C) a step of calculating a first value of the parameter corresponding to the first cylinder while the reducing control in the step (B) is in execution;

(D) a step of performing reducing control to reduce the deviation of the air-fuel ratio in a second cylinder of the two cylinders;

(E) a step of calculating a second value of the parameter corresponding to the second cylinder while the reducing control in the step (D) is in execution; and

(F) a step of identifying one of the two cylinders having a most significant deviation of the air-fuel ratio based on the first and second values.

Preferably, in the step (F), the control apparatus identifies the cylinder corresponding to one of the first and second values having a larger value on a normal side, as the one of the cylinders.

Preferably, one of the two cylinders is a cylinder estimated to have one of a lean- and a rich-side deviations in the air-fuel ratio, and the other cylinder is a cylinder estimated to have the other of the lean- and rich-side deviations in the air-fuel ratio.

Preferably, in the step (F), the control apparatus identifies the cylinder corresponding to one of the first and second values having a larger value on the normal side, as the one of the cylinders having a largest lean- or rich-side deviation of the air-fuel ratio.

Preferably, the first cylinder and the second cylinder are opposite cylinders spaced at a combustion interval equal to a half cycle of the internal combustion engine.

Preferably, the output waveform from the air-fuel ratio sensor is a periodic waveform with a period equal to one cycle of the internal combustion engine.

Preferably, in the step (A), the control apparatus identifies the two cylinders based on a lean-side peak phase and a rich-side peak phase of the output waveform from the air-fuel ratio sensor.

Preferably, in the step (A), the control apparatus identifies a source cylinder for exhaust gas detected by the air-fuel ratio sensor at a point in time of the lean-side peak phase, as a cylinder estimated to have a lean-side deviation of the air-fuel ratio, and identifies a source cylinder for exhaust gas detected by the air-fuel ratio sensor at a point in time of the rich-side peak phase, as a cylinder estimated to have a rich-side deviation of the air-fuel ratio.

Preferably, the control apparatus is configured to execute, when detecting variation abnormality:

(G) a step of calculating the parameter;

(H) a step of determining whether or not the calculated parameter is a value between a predetermined primary-determination upper limit value and a predetermined primary-determination lower limit value;

(I) a step of performing reducing control to reduce the deviation of the air-fuel ratio in one cylinder having a most significant deviation of the air-fuel ratio when the calculated parameter is determined to be a value between the predetermined primary-determination upper limit value and the predetermined primary-determination lower limit value;

(J) a step of calculating the parameters while the reducing control is in execution; and

(K) a step of comparing the parameter calculated while the reducing control is in execution with a predetermined secondary determination value to determine whether or not variation abnormality is present,

wherein the control apparatus executes the steps (A) to (F) when identifying the one cylinder having the most significant deviation of the air-fuel ratio in the step (I).

The present invention exerts an excellent effect of identifying one cylinder having the most significant deviation of the air-fuel ratio.

Further features of the present invention will become apparent from the following description of exemplary embodiments (with reference to the attached drawings).

### BRIEF DESCRIPTION OF THE DRAWINGS

FIG. 1 is a schematic diagram of an internal combustion engine according to an embodiment of the present invention;

FIG. 2 is a graph depicting output characteristics of a pre-catalyst sensor and a post-catalyst sensor;

FIG. 3 is a graph depicting a fluctuation in exhaust air-fuel ratio in accordance with the degree of an inter-cylinder variation in air-fuel ratio;

FIG. 4 is a graph depicting an output waveform from the pre-catalyst sensor;

FIG. 5 is a graph depicting a relation between an imbalance rate and an output fluctuation parameter;

FIG. 6A is a diagram depicting a first example of an identification method according to the present embodiment;

FIG. 6B is a diagram depicting a first example of an identification method according to the present embodiment;

FIG. 6C is a diagram depicting a first example of an identification method according to the present embodiment;

FIG. 6D is a diagram depicting a first example of an identification method according to the present embodiment;

FIG. 7A is a diagram depicting a second example of an identification method according to the present embodiment;

FIG. 7B is a diagram depicting a second example of an identification method according to the present embodiment;

FIG. 7C is a diagram depicting a second example of an identification method according to the present embodiment;

FIG. 7D is a diagram depicting a second example of an identification method according to the present embodiment;

FIG. 8 is a schematic diagram depicting a configuration of a V6 engine;

FIG. 9 is a graph depicting an output waveform from a pre-catalyst sensor in the V6 engine;

FIG. 10A is a diagram depicting a third example of an identification method according to the present embodiment;

FIG. 10B is a diagram depicting a third example of an identification method according to the present embodiment;

FIG. 10C is a diagram depicting a third example of an identification method according to the present embodiment;

FIG. 10D is a diagram depicting a third example of an identification method according to the present embodiment;

FIG. 11A is a diagram depicting a fourth example of an identification method according to the present embodiment;

FIG. 11B is a diagram depicting a fourth example of an identification method according to the present embodiment;

FIG. 11C is a diagram depicting a fourth example of an identification method according to the present embodiment;

FIG. 11D is a diagram depicting a fourth example of an identification method according to the present embodiment;

FIG. 12 is a flowchart of an identification process according to the present embodiment;

FIG. 13 is a graph illustrating a requested value for the imbalance rate;

FIG. 14 is a graph depicting characteristic lines obtained in a comparative example where the pre-catalyst sensor is a tolerance upper limit article and a comparative example where the pre-catalyst sensor is a tolerance lower limit article;

FIG. 15 is a graph depicting a comparative example where a detection request imbalance rate Bz is 60(%);

FIG. 16 is a graph depicting a comparative example where a detection request imbalance rate Bz is 40(%);

FIG. 17 is a graph illustrating a measure taken for the case in FIG. 16;

FIG. 18 is a graph illustrating a method for setting a primary-determination upper limit value, a primary-determination lower limit value, and a secondary determination value according to the present embodiment;

FIG. 19A is a table of the imbalance rate of a case where the reducing control (forced active control) is performed;

FIG. 19B is a table of the imbalance rate of a case where the reducing control is not performed; and

FIG. 20 is a flowchart of a variation abnormality detection process.

### DESCRIPTION OF THE EMBODIMENTS

An embodiment of the present invention will be described below with reference to the attached drawings.

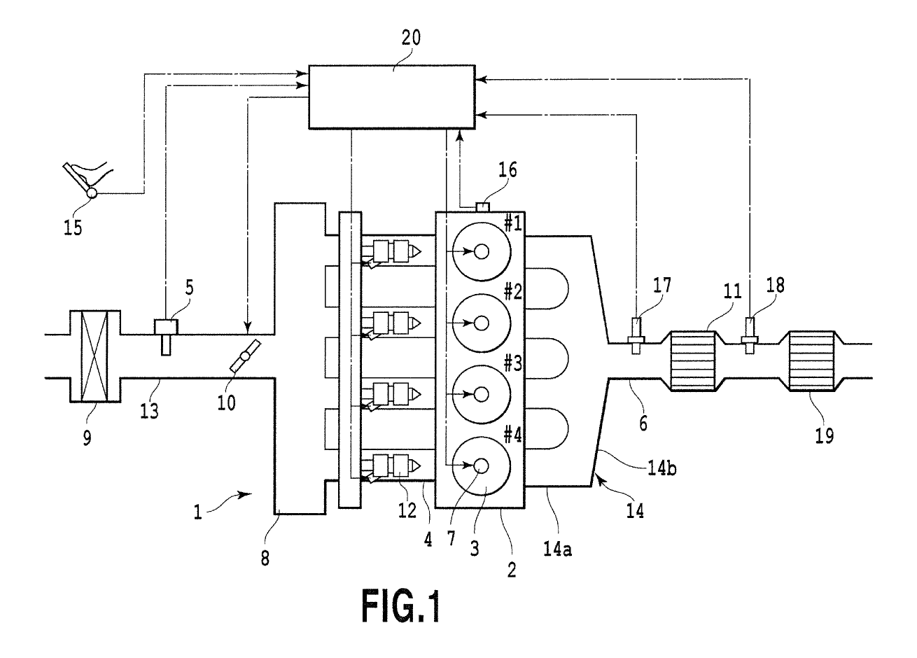

FIG. 1 is a schematic diagram of an internal combustion engine according to the present embodiment. An internal combustion engine (engine) 1 combusts a mixture of fuel and air inside a combustion chamber 3 formed in a cylinder block 2, and reciprocates a piston in the combustion chamber 3 to generate power. The internal combustion engine 1 according to the present embodiment is a multicylinder internal combustion engine mounted in a car, more specifically, an inline-four spark ignition internal combustion engine (gasoline engine). The internal combustion engine 1 includes #1 to #4 cylinders. The number, type, and the like of the cylinders in the internal combustion engine 1 are not particularly limited.

Although not depicted in the drawings, a cylinder head of the internal combustion engine 1 includes intake valves each disposed at a corresponding cylinder to open and close a corresponding intake port and exhaust valves each disposed at a corresponding cylinder to open and close a corresponding exhaust port. Each intake valve and each exhaust valve are opened and closed by a cam shaft. The cylinder head includes ignition plugs 7 each attached to a top portion of the cylinder head for the corresponding cylinder to ignite the air-fuel mixture in the combustion chamber 3.

The intake port of each cylinder is connected, via a branch pipe 4 for the cylinder, to a surge tank 8 that is an intake air aggregation chamber. An intake pipe 13 is connected to an upstream side of the surge tank 8, and an air cleaner 9 is provided at an upstream end of the intake pipe 13. The intake pipe 13 incorporates an air flow meter 5 (intake air amount detection device) for detecting the amount of intake air and an electronically controlled throttle valve 10, the air flow meter 5 and the throttle valve 10 being arranged in order from the upstream side. The intake port, the branch pipe 4, the surge tank 8, and the intake pipe 13 form an intake passage.

Each cylinder includes an injector (fuel injection valve) 12 disposed therein to inject fuel into the intake passage, particularly the intake port. The fuel injected by the injector 12 is mixed with intake air to form an air-fuel mixture, which is then sucked into the combustion chamber 3 when the intake valve is opened. The air-fuel mixture is compressed by the piston and then ignited and combusted by the ignition plug 7. The injector may inject fuel directly into the combustion chamber 3.

On the other hand, the exhaust port of each cylinder is connected to an exhaust manifold 14. The exhaust manifold 14 includes a branch pipe 14a for each cylinder which forms an upstream portion of the exhaust manifold 14 and an exhaust aggregation section 14b forming a downstream portion of the exhaust manifold 14. An exhaust pipe 6 is connected to the downstream side of the exhaust aggregation section 14b. The exhaust port, the exhaust manifold 14, and the exhaust pipe 6 form an exhaust passage.

Furthermore, the exhaust passage located downstream of the exhaust aggregation section 14b of the exhaust manifolds 14 forms an exhaust passage common to the #1 to #4 cylinders that are the plurality of cylinders.

Catalysts each including a three-way catalyst, that is, an upstream catalyst 11 and a downstream catalyst 19, are arranged in series and attached to an upstream side and a downstream side, respectively, of the exhaust pipe 6. The catalysts 11 and 19 have an oxygen storage capacity (O2 storage capability). That is, the catalysts 11 and 19 store excess air in exhaust gas to reduce NOx when the air-fuel ratio of exhaust gas is higher (leaner) than a stoichiometric ratio (theoretical air-fuel ratio, for example, A/F=14.5). Furthermore, the catalysts 11 and 19 emit stored oxygen to oxidize HC and CO in the exhaust gas when the air-fuel ratio of exhaust gas is lower (richer) than the stoichiometric ratio.

A first air-fuel ratio sensor and a second air-fuel ratio sensor, that is, a pre-catalyst sensor 17 and a post-catalyst sensor 18, are installed upstream and downstream, respectively, of the upstream catalyst 11 to detect the air-fuel ratio of exhaust gas. The pre-catalyst sensor 17 and the post-catalyst sensor 18 are installed immediately before and after the upstream catalyst, respectively, to detect the air-fuel ratio based on the concentration of oxygen in the exhaust. The pre-catalyst sensor 17 corresponds to an “air-fuel ratio sensor” according to the present invention.

The ignition plug 7, the throttle valve 10, the injector 12, and the like are electrically connected to an electronic control unit (hereinafter referred to as an ECU) 20 serving as a control apparatus or a control unit. The ECU 20 includes a CPU, a ROM, a RAM, an I/O port, and a storage device, none of which is depicted in the drawings. Furthermore, the ECU 20 connects electrically to, besides the above-described airflow meter 5, pre-catalyst sensor 17, and post-catalyst sensor 18, a crank angle sensor 16 that detects the crank angle of the internal combustion engine 1, an accelerator opening sensor 15 that detects the opening of an accelerator, and various other sensors via A/D converters or the like (not depicted in the drawings). Based on detection values from the various sensors, the ECU 20 controls the ignition plug 7, the throttle valve 10, the injector 12, and the like to control an ignition period, the amount of injected fuel, a fuel injection period, a throttle opening, and the like in accordance with various program stored in the ROM so as to obtain desired outputs.

The throttle valve 10 includes a throttle opening sensor (not depicted in the drawings), which transmits a signal to the ECU 20. The ECU 20 feedback-controls the opening of the throttle valve 10 (throttle opening) so as to make the actual throttle opening equal to a target throttle opening dictated according to the accelerator opening.

Based on a signal from the air flow meter 5, the ECU 20 detects the amount of intake air, that is, an intake flow rate, which is the amount of air sucked per unit time. The ECU 20 detects a load on the engine 1 based on at least one of the followings: the detected throttle opening and the amount of intake air.

Based on a crank pulse signal from the crank angle sensor 16, the ECU 20 detects the crank angle itself and the number of rotations of the engine 1. Here, the “number of rotations” refers to the number of rotations per unit time and is used synonymously with rotation speed. According to the present embodiment, the number of rotations refers to the number of rotations per minute rpm.

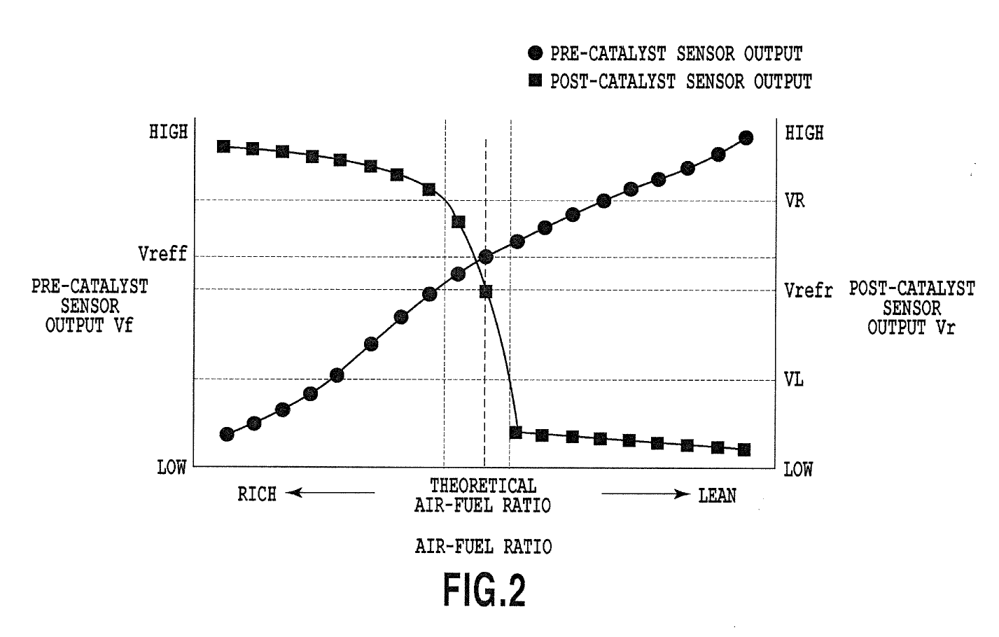

The pre-catalyst sensor 17 includes what is called a wide-range air-fuel ratio sensor and can consecutively detect a relatively wide range of air-fuel ratios. FIG. 2 depicts the output characteristic of the pre-catalyst sensor 17. As depicted in FIG. 2, the pre-catalyst sensor 17 outputs a voltage signal Vf of a magnitude proportional to an exhaust air-fuel ratio. An output voltage obtained when the exhaust air-fuel ratio is stoichiometric is Vreff (for example, 3.3 V).

On the other hand, the post-catalyst sensor 18 includes what is called an O2 sensor or an oxygen sensor and has a Z characteristic that an output value from the post-catalyst sensor 18 changes rapidly beyond the stoichiometric ratio. FIG. 2 depicts the output characteristic of the post-catalyst sensor. As depicted in FIG. 2, an output voltage obtained when the exhaust air-fuel ratio is stoichiometric, that is, a stoichiometrically equivalent value is Vrefr (for example, 0.45 V). The output voltage of the post-catalyst sensor 21 varies within a predetermined range (for example, from 0 V to 1 V). When the exhaust air-fuel ratio is leaner than the stoichiometric ratio, the output voltage of the post-catalyst sensor is lower than the stoichiometrically equivalent value Vrefr. When the exhaust air-fuel ratio is richer than the stoichiometric ratio, the output voltage of the post-catalyst sensor is higher than the stoichiometrically equivalent value Vrefr.

The upstream catalyst 11 and the downstream catalyst 19 simultaneously remove NOx, HC, and CO, which are harmful components in the exhaust, when the air-fuel ratio of exhaust gas flowing into each of the catalysts is close to the stoichiometric ratio. The range (window) of the air-fuel ratio within which the three components can be efficiently removed for purification at the same time is relatively narrow.

Thus, during normal operation, the ECU 20 performs air-fuel ratio feedback control so as to control the air-fuel ratio of exhaust gas discharged from the combustion chamber 3 and fed to the upstream catalyst 11 to the neighborhood of the stoichiometric ratio. The air-fuel ratio feedback control includes main air-fuel ratio control that controls the air-fuel ratio of an air-fuel mixture, specifically the amount of injected fuel, to make the exhaust air-fuel ratio detected by the pre-catalyst sensor 17 equal to the stoichiometric ratio, a predetermined target air-fuel ratio and sub air-fuel ratio control that controls the air-fuel ratio of the air-fuel mixture, specifically the amount of injected fuel, to make the exhaust air-fuel ratio detected by the post-catalyst sensor 18 equal to the stoichiometric ratio.

The air-fuel ratio feedback control using the stoichiometric ratio as the target air-fuel ratio is referred to as stoichiometric control. The stoichiometric ratio corresponds to a reference air-fuel ratio.

For example, some of all the cylinders, particularly one cylinder, may become abnormal to cause a variation (imbalance) in the air-fuel ratio among the cylinders. For example, the injector 12 for the #1 cylinder may fail, and a larger amount of fuel may be injected in the #1 cylinder than by the remaining cylinders, the #2, #3, and #4 cylinders. Thus, the air-fuel ratio in the #1 cylinder may deviate significantly toward a rich side compared to the air-fuel ratios in the #2 to #4 cylinders. Even in this case, the air-fuel ratio of total gas supplied to the pre-catalyst sensor 17, that is, the average value of the air-fuel ratios in the cylinders, may be controlled to the stoichiometric ratio by performing the above-described stoichiometric control to apply a relatively large amount of correction. However, the air-fuel ratios of the individual cylinders are such that the air-fuel ratio in the #1 cylinder is much richer than the stoichiometric ratio, whereas and the air-fuel ratio in the #2, #3, and #4 cylinders are slightly leaner than the stoichiometric ratio. Thus, the air-fuel ratios are only totally in balance; only the total air-fuel ratio is stoichiometric. This is obviously not preferable for emission control. Thus, the present embodiment includes an apparatus that detects such inter-cylinder air-fuel ratio variation abnormality.

An aspect of variation abnormality detection according to the present embodiment will be described below.

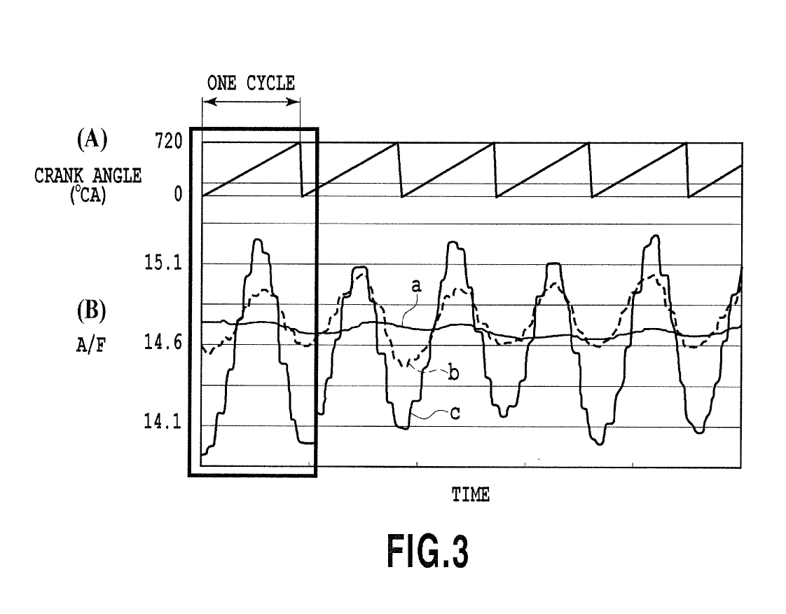

As depicted in FIG. 3, a variation in the air-fuel ratio among the cylinders increases a fluctuation in the exhaust air-fuel ratio. Air-fuel ratio lines a, b, c in (B) indicate air-fuel ratios detected by the pre-catalyst sensor 17 when no variation in air-fuel ratio occurs, when only one cylinder has a rich-side deviation at an imbalance rate of 20%, and when only one cylinder has a rich-side deviation at an imbalance rate of 50%, respectively. As seen in the air-fuel ratio lines, the amplitude of the variation in air-fuel ratio increases consistently with the degree of the variation among the cylinders.

The imbalance rate as used herein is one of parameters correlated with the degree of the variation in air-fuel ratio among the cylinders. That is, the imbalance rate is a value representing the rate at which, if only one of all the cylinders has an air-fuel ratio deviating from the air-fuel ratio in the remaining cylinders, the air-fuel ratio in the cylinder with the air-fuel ratio deviation (imbalance cylinder) deviates from the air-fuel ratio in the cylinders with no air-fuel ratio deviation (balance cylinder). In the present embodiment, the imbalance rate is represented by Formula (1). As imbalance rate B is apart from 1, the deviation of the air-fuel ratio in the imbalance cylinder from the air-fuel ratio in the balance cylinder increases and the degree of the variation in air-fuel ratio increases.

$$B = \frac{A / Fb}{A / Fib} \qquad ( 1 )$$

A/Fb denotes the air-fuel ratio in the balance cylinder, and A/Fib denotes the air-fuel ratio in the imbalance cylinder. The imbalance rate is generally expressed in percentage. In this case, the imbalance rate B(%) is expressed by Formula (1)′. An increase in the absolute value of the imbalance rate B(%) increases the deviation of the air-fuel ratio in the imbalance cylinder from the air-fuel ratio in the balance cylinder and the degree of a variation in air-fuel ratio. The imbalance rate is hereinafter expressed in percentage unless otherwise noted.

$$B ( \% ) = \{ \frac{A / Fb}{A / Fib} - 1 \} \times 100 \qquad {( 1 )}^{′}$$

As is understood from FIG. 3, a fluctuation in the output from the pre-catalyst sensor 17 increases consistently with the absolute value of the imbalance rate B(%), that is, the degree of the variation in air-fuel ratio.

Hence, utilizing this characteristic, the present embodiment calculates or detects an output fluctuation parameter X that is a parameter correlated with the degree of the fluctuation in the output from the pre-catalyst sensor 17 to detect variation abnormality based on the calculated output variation parameter X.

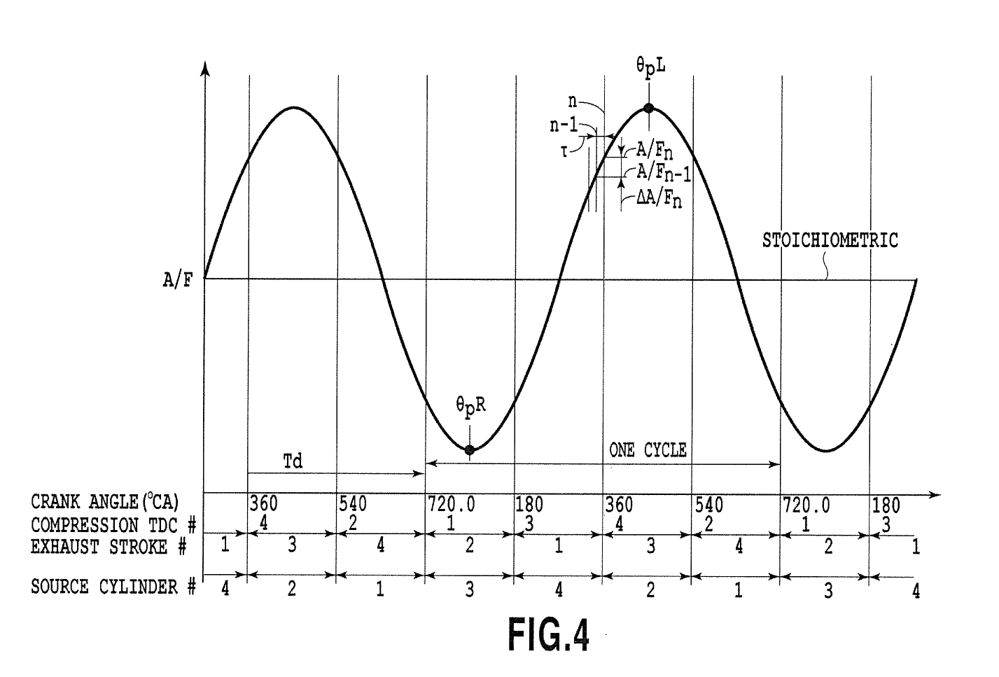

A method for calculating the output fluctuation parameter X will be described below. FIG. 4 depicts a transition of the pre-catalyst sensor output with respect to a crank angle. The crank angle is also referred to as a crank phase or simply a phase. The pre-catalyst sensor output may be the value of the air-fuel ratio A/F into which an output voltage Vf from the pre-catalyst sensor 17 is converted. However, the output voltage Vf from the pre-catalyst sensor 17 may be used directly as the pre-catalyst sensor output.

As depicted in FIG. 4, the pre-catalyst sensor output A/F varies at a period equal to one cycle of the engine (=720° CA; also referred to as one engine cycle). That is, an output waveform from the pre-catalyst sensor 17 is a periodic waveform with a period equal to one cycle of the engine. Furthermore, since the stoichiometric control is in execution, the output waveform from the pre-catalyst sensor 17 is a waveform varying substantially around the stoichiometric value.

As depicted in FIG. 4, the ECU 20 acquires the pre-catalyst sensor output A/F at each predetermined sample period τ during one engine cycle. The ECU 20 then determines the absolute value of the difference between a value A/Fn acquired at the current (n) timing and a value A/Fn−1 acquired at the preceding (n−1) timing (the absolute value is hereinafter referred to as an output difference). The output difference ΔA/Fn can be replaced with a differential value or the absolute value of an inclination obtained at the current timing.

ΔA/Fₙ=|A/Fₙ−A/Fₙ₋₁| (2)

Most simply stated, the output difference ΔA/Fn represents the magnitude of the fluctuation in the pre-catalyst sensor output. This is because the inclination of an air-fuel ratio diagram and thus the output difference ΔA/Fn increase consistently with the degree of the fluctuation. Consequently, the value of the output difference ΔA/Fn at a predetermined timing can be used as the output fluctuation parameter.

However, for improved accuracy, the present embodiment uses the average value of a plurality of output differences ΔA/Fn as the output fluctuation parameter. The present embodiment determines the output fluctuation parameter X by integrating the output difference ΔA/Fn at every sample period τ during M engine cycles (M denotes an integer of 2 or more, for example, M=100) and dividing the final integrated value by the number of samples. The output fluctuation parameter X increases consistently with the degree of the fluctuation in pre-catalyst sensor output.

Any value correlated with the degree of the fluctuation in pre-catalyst sensor output can be used as the output fluctuation parameter. For example, the output fluctuation parameter may be calculated based on the difference between the lean-side (maximum) peak and rich-side (minimum) peak (what is called, a peak-to-peak value) of the pre-catalyst sensor output during one engine cycle or the absolute value of the maximum peak or minimum peak of a second-order differential value. This is because an increase in the degree of the fluctuation in pre-catalyst sensor output increases the difference between the lean-side peak and rich-side peak of the pre-catalyst sensor output and the absolute value of the maximum peak or minimum peak of the second-order differential value.

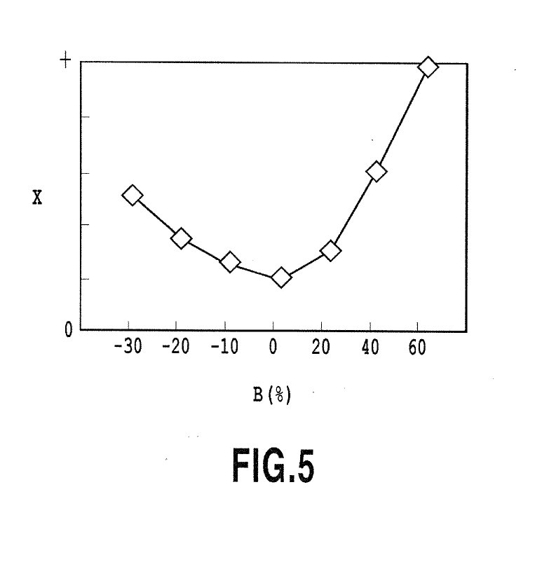

FIG. 5 depicts a relation between the imbalance rate IB (%) and the output fluctuation parameter X. As depicted in FIG. 5, the imbalance rate IB (%) and the output fluctuation parameter X have a strong correlation, and the output fluctuation parameter X tends to increase consistently with the absolute value of the imbalance rate IB.

Whether or not variation abnormality is present can be determined by comparing the calculated output fluctuation parameter X with a predetermined determination value α. For example, variation abnormality is determined to be present (abnormal) if the calculated output fluctuation parameter X is equal to or larger than the determination value α. Variation abnormality is determined to be absent (normal) if the calculated output fluctuation parameter X is smaller than the determination value α. As described below, the determination value α is set taking an OBD (On-Board Diagnosis) regulation value for exhaust emission into account.

The above-described variation abnormality detection apparatus can desirably identify one of all the cylinders that has the most significant deviation of the air-fuel ratio and may thus cause variation abnormality. For example, information on the one cylinder can be utilized for a subsequent repair or emission limitation or the like can be achieved by performing certain control on the one cylinder. The one cylinder with the most significant deviation of the air-fuel ratio is hereinafter referred to as the “abnormal cylinder” for convenience.

A possible method for identifying the abnormal cylinder identifies the abnormal cylinder based on the crank angle corresponding to the peak of such an output waveform from the pre-catalyst sensor as depicted in FIG. 4 (the crank angle is hereinafter referred to as the “peak phase”).

However, the method based on the peak phase involves two peak phases, a lean-side peak phase and a rich-side peak phase. Thus, two cylinders are forced to be identified, and identifying one abnormal cylinder is difficult.

Thus, to identify one abnormal cylinder, the present embodiment improves the method based on the peak phase. The identification method according to the present embodiment will be described below. However, before the description of the identification method according to the present embodiment, an identification method in a comparative example based on the peak phase will be described.

As depicted in FIG. 4, the engine has one cycle from 0° CA to 720° CA. According to the present embodiment, at 0° CA, the #1 cylinder is at the compression top dead center (compression TDC). At 180° CA, the #3 cylinder is at the compression top dead center. At 360° CA, the #4 cylinder is at the compression top dead center. At 540° CA, the #2 cylinder is at the compression top dead center. In other words, ignition occurs in the cylinders in the following order: the #1 cylinder, the #3 cylinder, the #4 cylinder, and the #2 cylinder.

In this case, a stroke between 0° CA and 180° CA corresponds to an exhaust stroke of the #2 cylinder. A stroke between 180° CA and 360° CA corresponds to an exhaust stroke of the #1 cylinder. A stroke between 360° CA and 540° CA corresponds to an exhaust stroke of the #3 cylinder. A stroke between 540° CA and 720° CA corresponds to an exhaust stroke of the #4 cylinder.

Time delay caused by transportation delay, response delay, or the like may occur before exhaust gas discharged from the combustion chamber 3 is actually detected by the pre-catalyst sensor 17. This delay time is denoted as Td. In the illustrated example, Td=360° CA for convenience. However, the length of the delay time Td varies according to the engine individual, the operational status of the engine, or the like.

For Td=360° CA, a source cylinder for exhaust gas detected by the pre-catalyst sensor 17 at each crank angle is as depicted in FIG. 4. For example, during a crank angle period between 0° and 180°, the source cylinder is #3, and exhaust gas discharged from the #3 cylinder is detected by the pre-catalyst sensor 17.

As indicated by the output waveform from the pre-catalyst sensor in the illustrated example, the source cylinder is #2 at the lean-side peak phase θpL and is #3 at the rich-side peak phase θpR. The interval between the lean-side peak phase θpL and the rich-side peak phase θpR is approximately equal to ½ engine cycle (=360° CA). Thus, the method in the comparative example identifies the #2 and #3 cylinders as two cylinders each estimated to have a deviation of the air-fuel ratio. The two cylinders are hereinafter referred to as “estimated abnormal cylinders” for convenience. In particular, the #2 cylinder is likely to have a lean-side deviation or the #3 cylinder is likely to have a rich-side deviation. Hence, the #2 cylinder is identified as a lean estimated abnormal cylinder estimated to have a lean-side deviation of the air-fuel ratio. The #3 cylinder is identified as a rich estimated abnormal cylinder estimated to have a rich-side deviation of the air-fuel ratio. As described above, the two cylinders are identified as estimated abnormal cylinders in association with the two peaks of the output waveform from the sensor.

However, the method in the comparative example poses the following problems. That is, although the two estimated abnormal cylinders, the lean estimated abnormal cylinder and the rich estimated abnormal cylinder, are identified which are treated as candidates for the abnormal cylinder, further identification, limitation, or narrowing-down is difficult. Since the output waveform from the pre-catalyst sensor 17 has a period equal to one cycle of the engine as described above, one of the cylinders, the lean estimated abnormal cylinder, and the other cylinder, the rich estimated abnormal cylinder, tend to provide opposite cylinders spaced at a combustion interval or a compression top dead center interval equal to a half cycle of the engine (=360° CA). Then, as described above, a distinction fails to be made between the #2 cylinder as the lean estimated abnormal cylinder (hereinafter also referred to as “#2 lean”) and the #3 cylinder as the rich estimated abnormal cylinder (#3 rich). Thus, determining which of the cylinders is the abnormal cylinder is difficult. Other combinations of estimated abnormal cylinders that are difficult to identify include a combination of #1 rich and #4 lean, a combination of #2 rich and #3 lean, an a combination of #1 lean and #4 rich. At most one of these four patterns can be identified, but one cylinder of that pattern is difficult to identify.

Thus, the identification method according to the present embodiment involves, after identifying one of the four patterns, performing reducing control to reduce a deviation of the air-fuel ratio on each of the two estimated abnormal cylinders (hereinafter referred to as “forced active control” for convenience) to calculate two output fluctuation parameters X (i.e., a first value and a second value of the output fluctuation parameter X). Then, based on the two output fluctuation parameters X (i.e., the first and second values), one abnormal cylinder is identified from the two estimated abnormal cylinders.

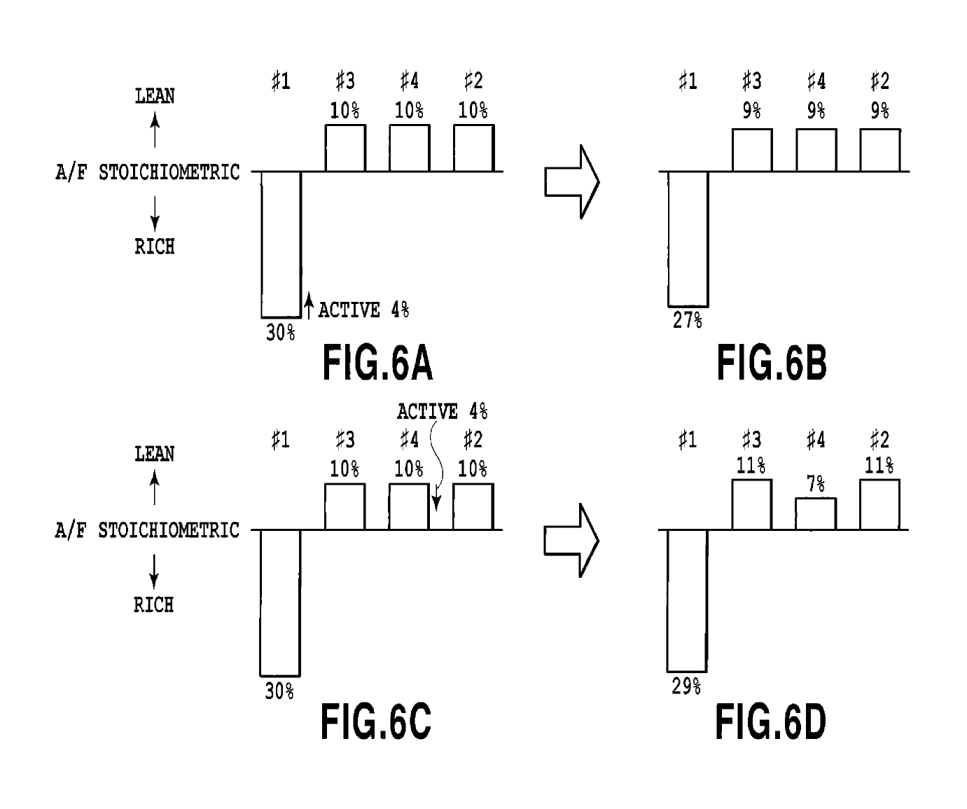

The identification method according to the present embodiment will be generally described below. The identification method is carried out by the ECU 20. FIG. 6 depicts a first example and specifically an example where the combination of #1 rich and #4 lean has already been identified using the method in the comparative example. As depicted in FIG. 6(A), the #1 cylinder is actually the abnormal cylinder with the largest rich-side deviation, whereas the #4 cylinder is not the abnormal cylinder. However, the method in the comparative example determines the #4 cylinder to be a candidate for the abnormal cylinder in addition to the #1 cylinder.

FIG. 6A depicts a state where the forced active control has not been performed yet, that is, a normal control state where stoichiometric control has been performed. The abnormality in the #1 cylinder has led to a rich-side deviation of the #1 cylinder at a relatively high imbalance rate of 30% (to be exact, the absolute value of the imbalance rate). The other cylinders, the #3 cylinder, the #4 cylinder, and the #2 cylinder, apparently have a lean-side deviation at an imbalance rate of 10%. However, this does not result from abnormality but from the stoichiometric control. That is, the stoichiometric control making the air-fuel ratio of total gas stoichiometric results in a lean-side deviation in the #3 cylinder, the #4 cylinder, and the #2 cylinder at an imbalance rate of 10% in order to compensate for the rich-side deviation in the #1 cylinder at an imbalance rate of 30%.

In the state in FIG. 6(A), such forced active control as reduces the rich-side deviation in the #1 cylinder is performed. Specifically, the amount of fuel injected in the #1 cylinder is forcibly or actively reduced by a value equivalent to an imbalance rate of 4%. Then, the air-fuel ratios in the cylinders are changed as depicted in FIG. 6(B). The stoichiometric control is also performed while the forced active control is in execution. Thus, the #1 cylinder has a rich-side deviation at an imbalance rate of 27%, whereas the air-fuel ratio in the #3, #4, and #2 cylinders has a lean-side deviation at an imbalance rate of 9%.

With the forced active control in execution as depicted in FIG. 6B, the output fluctuation parameter X is calculated. A method for the calculation is as described above. Thus, one of the output fluctuation parameters that corresponds to the #1 cylinder, the output fluctuation parameter X(1) (i.e., the first value of the output fluctuation parameter X), is calculated. After the calculation ends, the forced active control is ended.

On the other hand, the state of the air-fuel ratios in the cylinders depicted in FIG. 6(C) is the same as the state of the air-fuel ratios in the cylinders depicted in FIG. 6(A). In the state depicted in FIG. 6(C), such forced active control as reduces the lean-side deviation in the #4 cylinder is performed. Specifically, the amount of fuel injected in the #4 cylinder is forcibly or actively increased by a value equivalent to an imbalance rate of 4%. In this manner, the amount by which injected fuel is increased is preferably equal to the amount by which injected fuel is reduced.

Then, the air-fuel ratios in the cylinders are changed as depicted in FIG. 6(D). The stoichiometric control is also performed while the forced active control is in execution. Thus, the #1 cylinder has a rich-side deviation at an imbalance rate of 29%, the #3 cylinder and the #2 cylinder have a lean-side deviation at an imbalance rate of 11%, and the #4 cylinder has a lean-side deviation at an imbalance rate of 7%.

In the state depicted in FIG. 6D, the output fluctuation parameters X are also calculated. Thus, the other output fluctuation parameter X(4) (i.e., the second value of the output fluctuation parameter X) corresponding to the #4 cylinder is calculated. After the calculation, the forced active control is ended.

Then, the abnormal cylinder is identified based on the output fluctuation parameter X(1) and the output fluctuation parameter X(4). Specifically, the cylinder corresponding to one of the output fluctuation parameters X(1) and X(4) that has a more normal side value, that is, a smaller value, is identified as the abnormal cylinder with a lean-side deviation or a rich-side deviation.

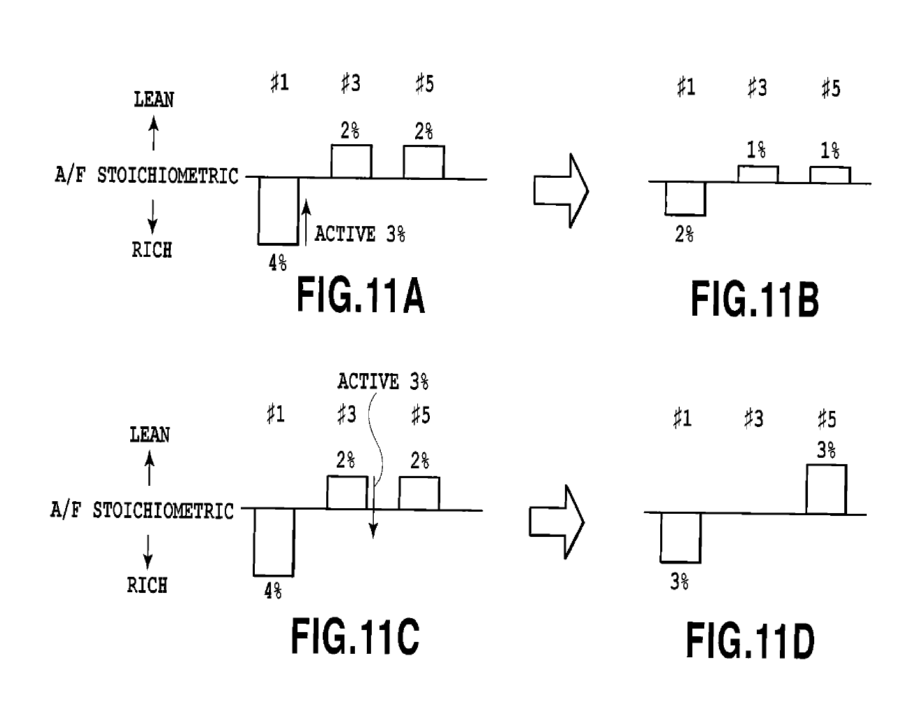

A comparison between FIG. 6(B) and FIG. 6(D) indicates that FIG. 6(B) allows smaller value of the output fluctuation parameter X to be calculated than FIG. 6(D). This is due to one of the following reasons: (1) the maximum value of the imbalance rate in all the cylinders (27% in FIG. 6(B) and 29% in FIG. 6(D)) is smaller in FIG. 6(B) than in FIG. 6(D), (2) the total value of the imbalance rates in all the cylinders (54% in FIG. 6(B) and 58% in FIG. 6(D)) is smaller in FIG. 6(B) than in FIG. 6(D), and (3) the sum (36% in FIG. 6(B) and 40% in FIG. 6(D)) of the rich-side maximum value (27% in FIG. 6(B) and 29% in FIG. 6(D)) and lean-side maximum value (9% in FIG. 6(B) and 11% in FIG. 6(D)) of the imbalance rates in all the cylinders is smaller in FIG. 6(B) than in FIG. 6(D).

Thus, in this example, X(1)<X(4). The #1 cylinder corresponding to X(1) is identified as the abnormal cylinder with a rich-side deviation.

As described above, the forced active control is performed on the two estimated abnormal cylinders, and as a result, the estimated abnormal cylinder for which the smaller output fluctuation parameter has been obtained is identified as the abnormal cylinder. The other estimated abnormal cylinder is indirectly determined not to be the abnormal cylinder. Thus, the two estimated abnormal cylinders are further narrowed down to enable one abnormal cylinder to be identified. Furthermore, the type of the deviation of the air-fuel ratio in the abnormal cylinder (lean-side deviation or rich-side deviation) can also be determined.

Now, a method for controlling the amount of fuel injected while the forced active control is in execution will be described in a supplementary manner.

As described above, the imbalance rate B(%) is expressed by:

$$B ( \% ) = \{ \frac{A / Fb}{A / Fib} - 1 \} \times 100 \qquad {( 1 )}^{′}$$

In this case, when the air-fuel ratio A/Fib in the imbalance cylinder deviates toward the lean side with respect to the air-fuel ratio A/Fb in the balance cylinder, the imbalance rate B(%) is negative. When the air-fuel ratio A/Fib in the imbalance cylinder deviates toward the rich side with respect to the air-fuel ratio A/Fb in the balance cylinder, the imbalance rate B(%) is positive.

If the amount of fuel injected in one cylinder is forcibly reduced by a value equivalent to an imbalance rate of 4% to change the cylinder from a state with no deviation of the air-fuel ratio (balance cylinder state) to a state with a deviation of the air-fuel ratio (imbalance cylinder state), the following formula is established.

$$- 4 ( \% ) = \{ \frac{14.5}{x} - 1 \} \times 100$$

14.5 on the right side denotes the stoichiometric ratio, and x denotes the air-fuel ratio in the imbalance cylinder state. The formula is solved as follows.

x=15.10

When the amount of fuel injected before the reduction is denoted by Q and the amount of fuel injected after the reduction is denoted by Q′, the following formula is established.

$$\frac{14.5 Q}{{Q}^{′}} = 15.10$$

14.5Q on the left side denotes the amount of air sucked after the reduction. This amount is the same as the amount of air sucked before the reduction. The formula is solved as follows.

Q′=0.96Q

In other words, reducing the amount Q of fuel injected before the reduction by 4% results in the amount Q′ of fuel injected after the reduction. That is, reducing the amount of fuel injected by a value equivalent to an imbalance rate of 4% corresponds to reducing the amount Q of fuel injected before the reduction by 4%.

Here, the amount Q of fuel injected in the normal state before the reduction, that is, the amount Q of fuel injected during the stoichiometric control, is expressed by:

Q=K1+Qb+K2

Qb denotes the basic amount of fuel injected which is dictated based on the operational status of the engine (particularly the number of rotations and a load). K1 denotes a main feedback correction coefficient for air-fuel ratio main feedback control. K2 denotes a sub feedback correction amount for air-fuel ratio sub feedback control.

On the other hand, when a correction coefficient for the forced active control is K3=0.96, the amount Q′ of fuel injected after the injection is expressed by:

Q′=Q×K3=(K1×Qb+K2)×K3

Hence, while the forced active control is in execution, the ECU 20 calculates the amount Q′ of fuel injected based on the formula above and delivers an injection indication signal corresponding to the calculated amount Q′ of fuel injected, to the injector 12.

The value of 4% is used herein, but 4% is only illustrative and any value may be used. In a similar example described below and when the amount of fuel injected is forcibly injected, the amount of fuel injected can be controlled in a manner similar to the above-described manner.

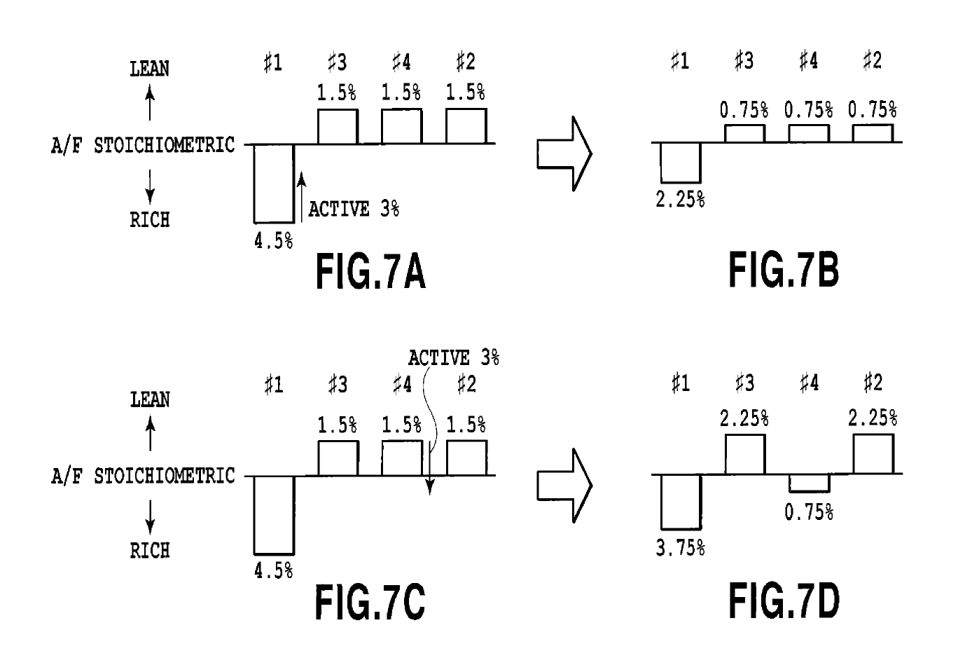

FIG. 7 depicts a second example and specifically an example where the combination of #1 rich and #4 lean has already been identified using the method in the comparative example as is the case with the first example. As depicted in FIG. 7A, the #1 cylinder is the abnormal cylinder with the largest rich-side deviation. However, the magnitude of the rich-side deviation is equivalent to an imbalance rate of 4.5%, which is smaller than in the first example (30%).

As described above, examples of the deviation of the air-fuel ratio in the abnormal cylinder include a relatively significant deviation of the air-fuel ratio as in the first example and a relatively slight deviation of the air-fuel ratio as in the second example. When a relatively significant deviation of the air-fuel ratio occurs, variation abnormality is desirably determined to be present during variation abnormality detection. On the other hand, when only a relatively slight deviation of the air-fuel ratio occurs, variation abnormality need not necessarily be determined to be present in connection with the OBD regulation value. In that case, the abnormal cylinder identified using the identification method according to the present embodiment is not necessarily abnormal. However, it should be noted that the term “abnormal cylinder” is used herein for convenience.

In the state before the forced active control depicted in FIG. 7(A), the #1 cylinder has a rich-side deviation at a relatively low imbalance rate of 4.5%. The other cylinders, that is, the #3 cylinder, the #4 cylinder, and the #2 cylinder, apparently have a lean-side deviation at an imbalance rate of 1.5%. This results from the stoichiometric control as described above.

In the state in FIG. 7(A), such forced active control as reduces the rich-side deviation in the #1 cylinder is performed. Specifically, the amount of fuel injected in the #1 cylinder is forcibly or actively reduced by a value equivalent to an imbalance rate of 3%. Then, the air-fuel ratios in the cylinders are changed as depicted in FIG. 7(B). The stoichiometric control is also performed while the forced active control is in execution. Thus, the #1 cylinder has a rich-side deviation at an imbalance rate of 2.25%, whereas the air-fuel ratio in the #3, #4, and #2 cylinders has a lean-side deviation at an imbalance rate of 0.75%.

With the forced active control in execution as depicted in FIG. 7(B), the output fluctuation parameter X is calculated. Thus, the output fluctuation parameter X(1) corresponding to the #1 cylinder is calculated. After the calculation, the forced active control is ended.

On the other hand, the state of the air-fuel ratios in the cylinders depicted in FIG. 7(C) is the same as the state of the air-fuel ratios in the cylinders depicted in FIG. 7(A). Then, in the state depicted in FIG. 7(C), such forced active control as reduces the lean-side deviation in the #4 cylinder is performed. Specifically, the amount of fuel injected in the #4 cylinder is forcibly or actively increased by a value equivalent to an imbalance rate of 3%. Then, the air-fuel ratios in the cylinders are changed as depicted in FIG. 7(D). The stoichiometric control is also performed while the forced active control is in execution. Thus, the #1 cylinder has a rich-side deviation at an imbalance rate of 3.75%, the air-fuel ratio in the #3 and #2 cylinders has a lean-side deviation at an imbalance rate of 2.25%, and the air-fuel ratio in the #4 cylinder has a lean-side deviation at an imbalance rate of 2.25%.

In the state in FIG. 7(D), the output fluctuation parameter X is also calculated. Thus, the output fluctuation parameter X(4) corresponding to the #4 cylinder is calculated. After the calculation, the forced active control is ended.

Then, the output fluctuation parameter X(1) and the output fluctuation parameter X(4) are compared with each other. The cylinder corresponding to the output fluctuation parameter with a smaller value is identified as the abnormal cylinder with a lean-side deviation or a rich-side deviation.

A comparison between FIG. 7(B) and FIG. 7(D) indicates that FIG. 7(B) allows smaller values of the output fluctuation parameter X to be calculated than FIG. 7(D). Thus, in this example, X(1)<X(4), and the #1 cylinder corresponding to X(1) is identified as the abnormal cylinder with a rich-side deviation.

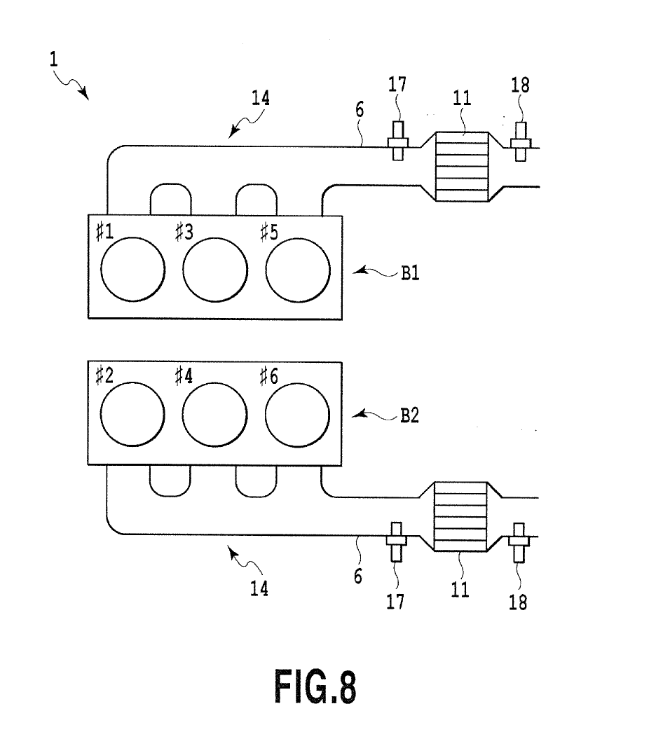

Now, a third example will be described. In the third example, the identification method according to the present embodiment is applied to a V6 engine. The configuration of the engine is as depicted in FIG. 8. The engine 1 has a first bank (for example, a right bank) B1 and a second bank (for example, a left bank) B2. The first bank B1 is provided with a #1 cylinder, a #3 cylinder, and a #5 cylinder, whereas the second bank B2 is provided with a #2 cylinder, a #4 cylinder, and a #6 cylinder. Each of the banks is provided with an exhaust manifold 14, an exhaust pipe 6, an upstream catalyst 11, a pre-catalyst sensor 17, and a post-catalyst sensor 18. The exhaust pipes 6 of the banks are merged together on a downstream side not depicted in FIG. 8. On a downstream side of the position of the merger, a downstream catalyst 19 common to the banks is provided. Although not depicted in the drawings, the remaining part of the configuration is the same as the corresponding part of the inline-four engine depicted in FIG. 1 and will not be described below in detail. In the V6 engine 1, on the first bank B1 side, the air-fuel ratio sensor, that is, the pre-catalyst sensor 17, is installed on an exhaust passage common to the three cylinders, a #1 cylinder, a #3 cylinder, and a #5 cylinder. Similarly, on the second bank B2 side, the air-fuel ratio sensor, that is, the pre-catalyst sensor 17, is installed on an exhaust passage common to the three cylinders, a #2 cylinder, a #4 cylinder, and a #6 cylinder.

In this engine, the above-described air-fuel ratio control, variation abnormality detection, and abnormal cylinder identification process are independently executed on each of the banks. That is, control and processing similar to control and processing for the inline-four engine are executed on each bank. Thus, for example, for the first bank B1, the three cylinders #1, #3, and #5 are collectively treated like one inline-three engine. Control and processing similar to the control and processing for the inline-four engine are executed on this inline-three engine. This also applies to the second bank B2 side.

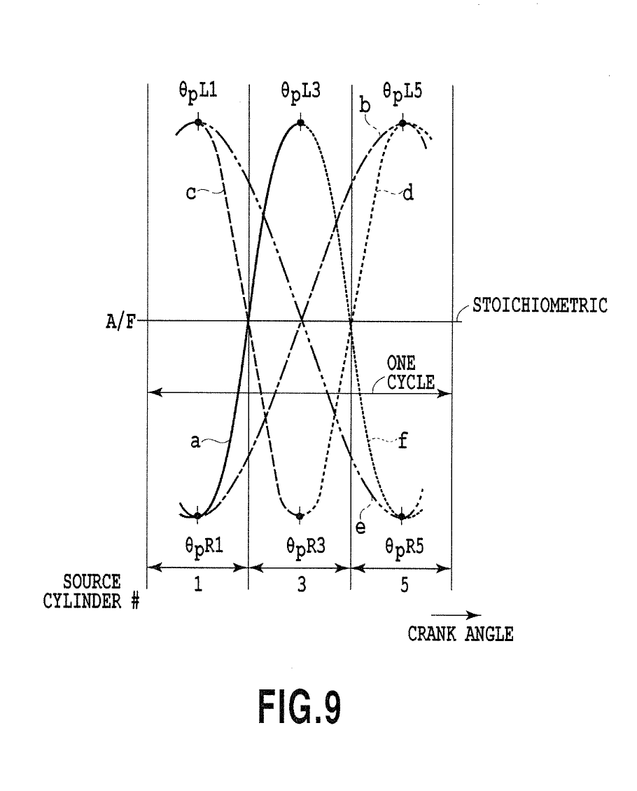

In this case, for example, for the first bank B1 side, ignition in the cylinder occurs in the following order: the #1 cylinder, the #3 cylinder, and the #5 cylinder. The combustion interval or compression top dead center interval between the #1 cylinder and the #3 cylinder and the #5 cylinder is 240° CA. Hence, the #1 cylinder, the #3 cylinder, and the #5 cylinder do not provide opposite cylinders in any combination. Furthermore, an output waveform from the pre-catalyst sensor 17 is as depicted in FIG. 9. The output waveform is a periodic waveform with a period equal to one engine cycle as is the case with the above-described example. However, the interval between a lean-side peak phase and a rich-side peak phase is not approximately 360° CA but approximately 240° CA or 480° CA. In other words, the output waveform is not symmetric with respect to a certain crank angle. As depicted in FIG. 9, any one of the following six patterns of the output waveform may appear.

(1) A waveform (a) in which a rich-side peak phase θpR1 is present in the phase interval of the #1 source cylinder and in which a lean-side peak phase θpL3 is present in the phase interval of the #3 source cylinder (a pattern of #1 rich and #3 lean).
(2) A waveform (b) in which the rich-side peak phase θpR1 is present in the phase interval of the #1 source cylinder and in which a lean-side peak phase θpL5 is present in the phase interval of the #5 source cylinder (a pattern of #1 rich and #5 lean).
(3) A waveform (c) in which a rich-side peak phase θpR3 is present in the phase interval of the #3 source cylinder and in which a lean-side peak phase θpL1 is present in the phase interval of the #1 source cylinder (a pattern of #3 rich and #1 lean).
(4) A waveform (d) in which the rich-side peak phase θpR3 is present in the phase interval of the #3 source cylinder and in which the lean-side peak phase θpL5 is present in the phase interval of the #5 source cylinder (a pattern of #3 rich and #5 lean).
(5) A waveform (e) in which the rich-side peak phase θpR5 is present in the phase interval of the #5 source cylinder and in which the lean-side peak phase θpL1 is present in the phase interval of the #1 source cylinder (a pattern of #5 rich and #1 lean).
(6) A waveform (f) in which the rich-side peak phase θpR5 is present in the phase interval of the #5 source cylinder and in which the lean-side peak phase θpL3 is present in the phase interval of the #3 source cylinder (a pattern of #5 rich and #3 lean).

In this case, the method in the comparative example enables two estimated abnormal cylinders to be identified. By way of example, a case will be described in which, in connection with the waveform (a), the #1 cylinder is identified as a rich estimated abnormal cylinder (#1 rich), whereas the #3 cylinder is identified as a lean estimated abnormal cylinder (#3 lean).

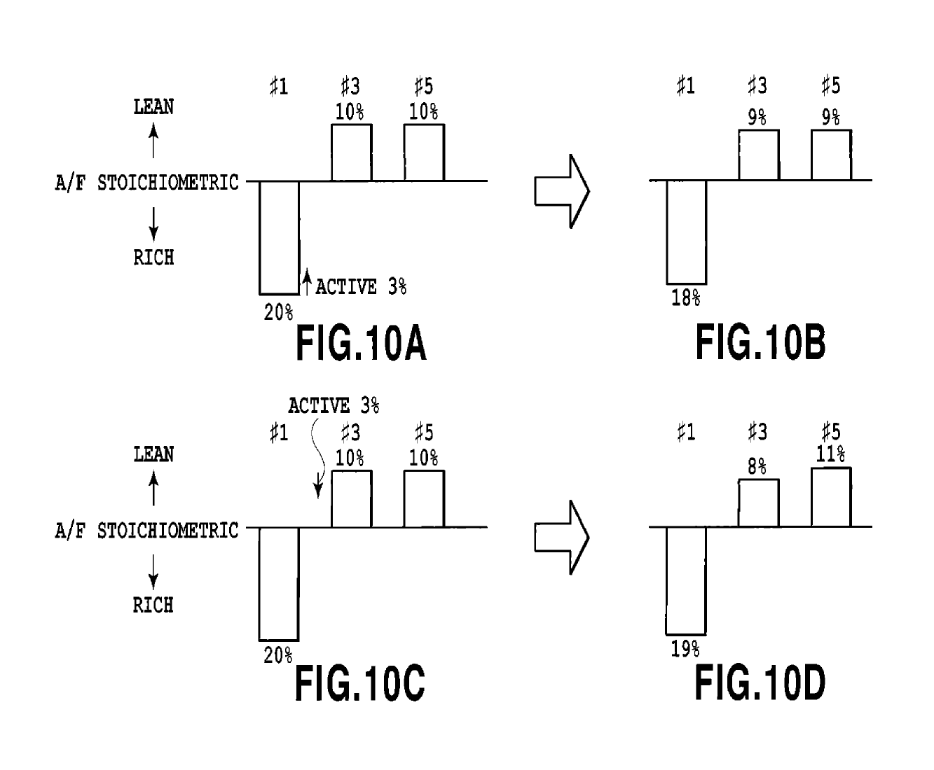

FIG. 10 depicts an example where the #1 cylinder is actually an abnormal cylinder with a significant and the largest rich-side deviation. As depicted in FIG. 10(A), before the forced active control, the #1 cylinder has a rich-side deviation at a relatively high imbalance rate of 20% due to abnormality in the #1 cylinder. The other cylinders, the #3 cylinder and the #5 cylinder, apparently have a lean-side deviation at an imbalance rate of 10%. However, this does not result from abnormality but from the stoichiometric control.

In the state depicted in FIG. 10(A), such forced active control as reduces the rich-side deviation in the #1 cylinder is performed. Specifically, the amount of fuel injected in the #1 cylinder is forcibly or actively reduced by a value equivalent to an imbalance rate of 3%. Then, the air-fuel ratios in the cylinders are changed as depicted in FIG. 10(B). The stoichiometric control is also performed while the forced active control is in execution. Thus, the #1 cylinder has a rich-side deviation at an imbalance rate of 18%, and the #3 cylinder and the #5 cylinder have a lean-side deviation at an imbalance rate of 9%.

With the forced active control in execution as depicted in FIG. 10(B), the output fluctuation parameter X is calculated. Thus, the output fluctuation parameter X(1) corresponding to the #1 cylinder is calculated. After the calculation, the forced active control is ended.

On the other hand, the state of the air-fuel ratios in the cylinders depicted in FIG. 10(C) is the same as the state of the air-fuel ratios in the cylinders depicted in FIG. 10(A). Then, in the state depicted in FIG. 10(C), such forced active control as reduces the lean-side deviation in the #3 cylinder is performed. Specifically, the amount of fuel injected in the #3 cylinder is forcibly or actively increased by a value equivalent to an imbalance rate of 3%. Then, the air-fuel ratios in the cylinders are changed as depicted in FIG. 10(D). The stoichiometric control is also performed while the forced active control is in execution. Thus, the #1 cylinder has a rich-side deviation at an imbalance rate of 19%, the air-fuel ratio in the #3 cylinder has a lean-side deviation at an imbalance rate of 8%, and the air-fuel ratio in the #5 cylinder has a lean-side deviation at an imbalance rate of 11%.

In the state in FIG. 10(D), the output fluctuation parameter X is also calculated. Thus, the output fluctuation parameter X(3) corresponding to the #3 cylinder is calculated. After the calculation, the forced active control is ended.

Then, the abnormal cylinder is identified based on the output fluctuation parameter X(1) and the output fluctuation parameter X(3). Specifically, the cylinder corresponding to one of the output fluctuation parameters X(1) and X(3) that has a smaller value is identified as the abnormal cylinder.

A comparison between FIG. 10(B) and FIG. 10(D) indicates that FIG. 10(B) allows smaller values of the output fluctuation parameter X to be calculated than FIG. 10(D). Thus, in this example, X(1)<X(3), and the #1 cylinder corresponding to X(1) is identified as the abnormal cylinder with a rich-side deviation.

Now, a fourth example will be described. Like the third example, the fourth example is an example where the present embodiment is applied to the V6 engine. However, the fourth example is different from the third example in that the #1 cylinder is an abnormal cylinder with not a significant but a slight rich-side deviation as depicted in FIG. 11A. In the description below, it is assumed that #1 rich and #3 lean have already been identified as is the case with the third example.

As depicted in FIG. 11(A), before the forced active control, the #1 cylinder has a rich-side deviation at a relatively low imbalance rate of 4% due to abnormality in the #1 cylinder. The other cylinders, the #3 cylinder and the #5 cylinder, apparently have a lean-side deviation at an imbalance rate of 2%. However, this does not result from abnormality but from the stoichiometric control.

In the state depicted in FIG. 11(A), such forced active control as reduces the rich-side deviation in the #1 cylinder is performed. Specifically, the amount of fuel injected in the #1 cylinder is forcibly or actively reduced by a value equivalent to an imbalance rate of 3%. Then, the air-fuel ratios in the cylinders are changed as depicted in FIG. 11(B). The stoichiometric control is also performed while the forced active control is in execution. Thus, the #1 cylinder has a rich-side deviation at an imbalance rate of 2%, and the #3 cylinder and the #5 cylinder have a lean-side deviation at an imbalance rate of 1%.

With the forced active control in execution as depicted in FIG. 11(B), the output fluctuation parameter X is calculated. Thus, the output fluctuation parameter X(1) corresponding to the #1 cylinder is calculated. After the calculation, the forced active control is ended.

On the other hand, the state of the air-fuel ratios in the cylinders depicted in FIG. 11(C) is the same as the state of the air-fuel ratios in the cylinders depicted in FIG. 11(A). Then, in the state depicted in FIG. 11(C), such forced active control as reduces the lean-side deviation in the #3 cylinder is performed. Specifically, the amount of fuel injected in the #3 cylinder is forcibly or actively increased by a value equivalent to an imbalance rate of 3%. Then, the air-fuel ratios in the cylinders are changed as depicted in FIG. 11(D). The stoichiometric control is also performed while the forced active control is in execution. Thus, the #1 cylinder has a rich-side deviation at an imbalance rate of 3%, the #3 cylinder has no deviation of the air-fuel ratio (an imbalance rate of 0%), and the #5 cylinder has a lean-side deviation at an imbalance rate of 3%.

In the state in FIG. 11(D), the output fluctuation parameter X is also calculated. Thus, the output fluctuation parameter X(3) corresponding to the #3 cylinder is calculated. After the calculation, the forced active control is ended.

Then, the output fluctuation parameter X(1) and the output fluctuation parameter X(3) are compared with each other. The cylinder corresponding to the output fluctuation parameter with a smaller value is identified as the abnormal cylinder with a lean-side deviation or a rich-side deviation.

A comparison between FIG. 11(B) and FIG. 11(D) indicates that FIG. 11(B) allows smaller values of the output fluctuation parameter X to be calculated than FIG. 11(D). Thus, in this example, X(1)<X(3), and the #1 cylinder corresponding to X(1) is identified as the abnormal cylinder with a rich-side deviation.

The several examples regarding the identification method according to the present embodiment have been described. However, the identification method according to the present embodiment is not limited to the above-described examples but is applicable to, for example, engines with different numbers of cylinders, engines in different forms, or engines of different types. The present embodiment will be continuously described taking, as an example, the inline-four engine depicted in FIG. 1.

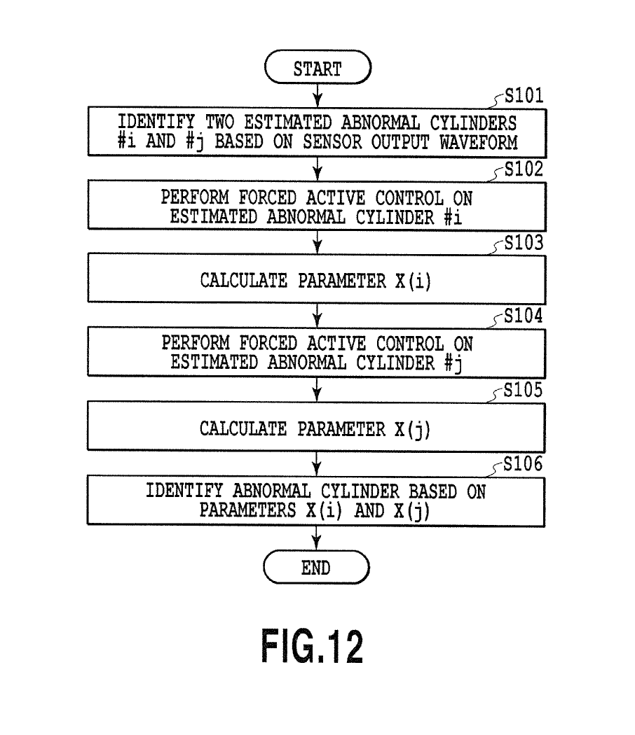

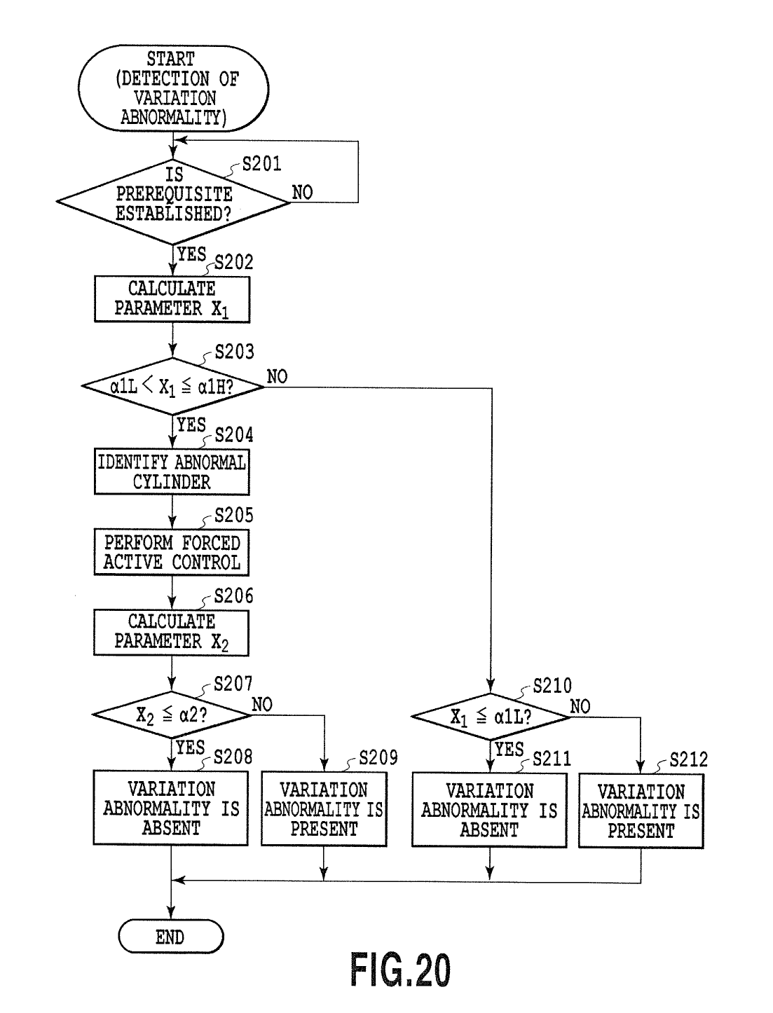

A more specific abnormal-cylinder identification process according to the present embodiment will be described. The identification process is executed by the ECU 20 in accordance with such an algorithm as illustrated in a flowchart in FIG. 12. The identification process is preferably executed only when a prerequisite (step S201 in FIG. 20) for a variation abnormality detection process is established. For easy understanding, the process will be described with appropriate reference to FIG. 4.

First, in step S101, two estimated abnormal cylinders #i and #j (i, j=1, 2, 3, or 4; i≠j) are identified based on an output waveform from the pre-catalyst sensor 17 during one engine cycle as depicted in FIG. 4.

Specifically, the ECU 20 constantly calculates such a relation between the crank angle and the source cylinder as depicted in FIG. 4, that is, determines from which of the cylinders exhaust gas detected by the pre-catalyst sensor 17 at a certain crank angle originates. In this case, the delay time Td may be calculated based on the operational status of the engine (for example, the number of rotations and the load) so that the source cylinder at the certain crank angle can be determined based on the delay time Td. For example, the cylinder set in an exhaust stroke the delay time Td before the current time may be determined to be the source cylinder. Alternatively, four phase intervals during one engine cycle which correspond to the four source cylinders, respectively, may be specified for each engine cycle based on the operational status of the engine. One of such four phase intervals is, for example, a phase interval between 0° CA and 180° CA corresponding to the #3 cylinder as depicted in FIG. 4. In this case, the source cylinder can be determined depending on to which of the phase intervals the point in time of a certain crank angle belongs.

Then, the ECU 20 determines the lean-side peak phase θpL and the rich-side peak phase θpR from the sensor output waveform. The ECU 20 identifies the source cylinder corresponding to the lean-side peak phase θpL as a lean estimated abnormal cylinder #i and identifies the source cylinder corresponding to the rich-side peak phase θpL as a rich estimated abnormal cylinder #j.

Then, in step S102, such forced active control as reduces a deviation of the air-fuel ratio is performed on the lean estimated abnormal cylinder #i, one of the estimated abnormal cylinders. At this time, the amount of fuel injected in the lean estimated abnormal cylinder #i is increased by a predetermined value.

Then, in step 103, the output fluctuation parameter X(i) is calculated. That is, the output fluctuation parameter X(i) is calculated while the forced active control is in execution in step S102. In this case, the ECU 20 integrates the above-described output difference ΔA/Fn at every sample period ti during M engine cycles (for example, M=100) and divides the final integral value by the number of samples to calculate the output fluctuation parameter X(i).

Once the output fluctuation parameter X(i) is calculated, the forced active control on the #i cylinder is ended. Then, in step S104, such forced active control as reduces a deviation of the air-fuel ratio is preformed on the rich estimated abnormal cylinder #j, the other estimated abnormal cylinder. In other words, the target cylinder for the forced active control is changed. At this time, the amount of fuel injected in the rich estimated abnormal cylinder #j is reduced by a predetermined value.

Then, in step S105, the output fluctuation parameter X(j) is calculated as is the case with step S103.

Once the output fluctuation parameter X(j) is calculated, the forced active control on the #j cylinder is ended. Then, in step 5106, the abnormal cylinder is identified based on the output fluctuation parameters X(i) and X(j).

Specifically, the ECU 20 compares the output fluctuation parameters X(i) and X(j) with each other to select one of the output fluctuation parameters that has a smaller value. Moreover, the ECU 20 finally identifies the estimated abnormal cylinder corresponding to the selected output fluctuation parameter as the abnormal cylinder. At the same time, the ECU 20 determines the type of the deviation of the air-fuel ratio in the abnormal cylinder (lean-side deviation or rich-side deviation). For example, when the lean estimated abnormal cylinder #i is identified as the abnormal cylinder, the ECU 20 determines the type of the deviation of the air-fuel ratio to be a lean-side deviation. These pieces of information on the abnormal cylinder are saved to the memory (RAM or the like) in the ECU 20 so as to be utilized for subsequent repair or the like.

The abnormal cylinder identification process completes as described above. In the above-described example, the output fluctuation parameter is calculated first for the lean estimated abnormal cylinder #i and then for the rich estimated abnormal cylinder #j. However, the order of the calculations may be reversed.

The abnormal cylinder identification process and method according to the present embodiment can be used for or applied to variation abnormality detection in various applications, stages, and methods. Most generally, the abnormal cylinder identification process and method according to the present embodiment are used to identify an abnormal cylinder that causes variation abnormality when the variation abnormality is detected (the variation abnormality is determined to be present) by comparing the output fluctuation parameter X with the determination value α as described above. The abnormal cylinder identification process and method according to the present embodiment have other preferred applications. The preferred applications will be described below.

In general, the output characteristics (gain, responsiveness, and the like) of the air-fuel ratio sensor actually installed in the engine vary between tolerance upper-limit products and tolerance lower-limit products due to manufacturing variations and the like. Hence, the calculated value of the output fluctuation parameter X corresponding to the imbalance rate B varies depending on the pre-catalyst sensor 17.

On the other hand, a desired value for the imbalance rate B which needs to be determined to be abnormal may be legally specified. In such a case, the determination value α is specified in view of the desired value.

However, it has been found that not all the air-fuel ratio sensors 17 can meet the desired value because of the variations among the pre-catalyst sensors 17. That is, it has been found that the tolerance upper-limit products allow abnormality to be detected when the output fluctuation parameter X is smaller than the desired value equivalent, whereas the tolerance lower-limit products may fail to allow abnormality to be detected unless the output fluctuation parameter X exceeds the desired value equivalent. This will be specifically described below.

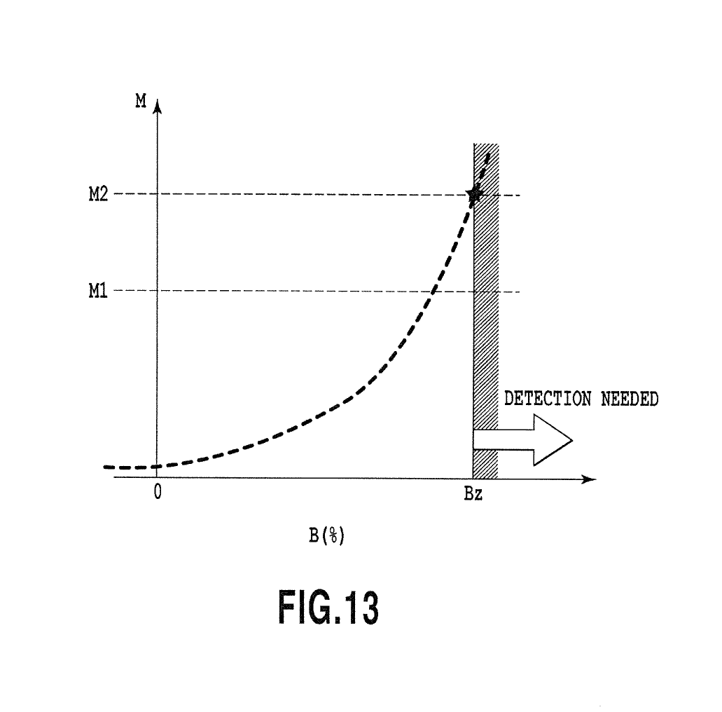

FIG. 13 is a graph illustrating the desired value for the imbalance rate B. The axis of abscissas represents the imbalance rate B(%). The axis of ordinate represents the amount of emission of a particular emission component, in this case, NOx. M1 denotes an emission regulation value legally specified for the amount of NOx emission, and M2 denotes a legally specified OBD regulation value. The OBD regulation value M2 is specified to be, for example, 1.5 times as large as the emission regulation value.

As depicted in FIG. 13, the amount of NOx emission M increases as the imbalance rate B(%) increases relative to 0, that is, as the amount of deviation of the air-fuel ratio in one cylinder having a deviation of the air-fuel ratio on the rich side (rich-side imbalance). The imbalance rate Bz(%) corresponding to the OBD regulation value M2 is the desired value. This desired value is hereinafter referred to as a detection-needed imbalance rate.

When the actual imbalance rate B(%) is higher than the detection-needed imbalance rate Bz(%), abnormality inevitably needs to be detected. This is because, if abnormality fails to be detected, the amount of NOx emission M exceeds the OBD regulation value M2. In other words, the detection-needed imbalance rate Bz (%) means a lower limit value for the imbalance rate B that needs to be determined to be abnormal.

The value of the detection-needed imbalance rate Bz (%) varies according to the type of the vehicle or the engine 1. However, the value falls within the range of 40% to 60%.

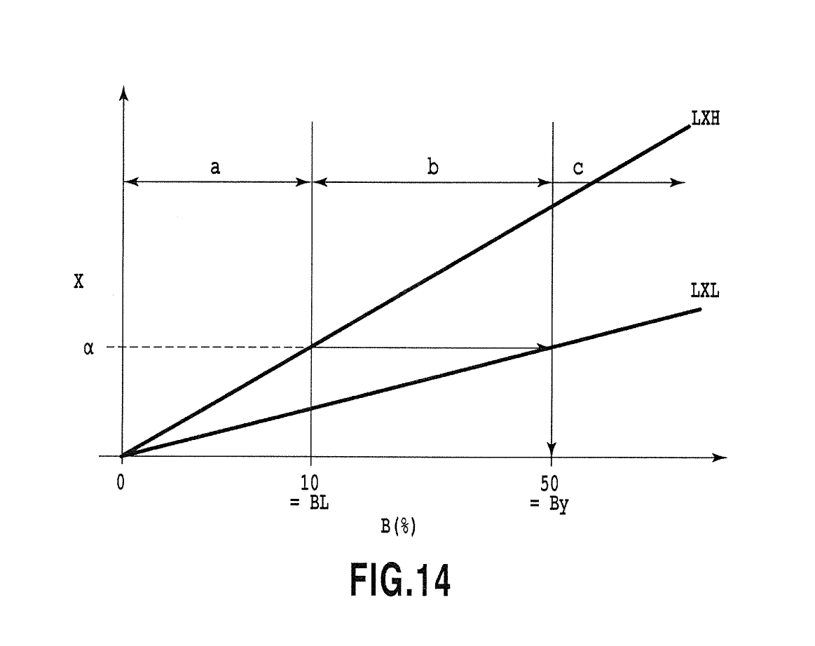

FIG. 14 depicts characteristics or characteristic lines representing the relation between the imbalance rate B(%) and the output fluctuation parameter X obtained when the pre-catalyst sensor 17 is a tolerance upper-limit product and when the pre-catalyst sensor 17 is a tolerance lower-limit product. In FIG. 14, LXH denotes a characteristic or a characteristic line obtained when the pre-catalyst sensor 17 is a tolerance upper-limit product, and LXL denotes a characteristic or a characteristic line obtained when the pre-catalyst sensor 17 is a tolerance lower-limit product. As is known, the tolerance upper-limit product refers to a product with the quickest response within the tolerance range. The tolerance lower-limit product refers to a product with the slowest response within the tolerance range. The present embodiment assumes that the pre-catalyst sensor 17, actually installed in the engine 1, is a normal sensor with responsiveness within the tolerance range.

As depicted in FIG. 14, the imbalance rate B(%) and the output fluctuation parameter X have a first order proportional relation or characteristic. However, the relation changes in accordance with the output characteristics of the pre-catalyst sensor 17 (hereinafter simply referred to as the sensor output characteristics). For example, the characteristic line LXH of the tolerance upper-limit product has a larger inclination than the characteristic line LXL of the tolerance lower-limit product. The inclination of the characteristic line changes between LXH and LXL depending on the actually installed sensor.

Now, a method for setting or adapting the determination value α in a comparative example will be described. As depicted in FIG. 14, first, the range (a) of the imbalance rate B(%) is determined which is inappropriate to determine to be abnormal (the range to be prevented from being determined to be abnormal) regardless of the sensor output characteristics. In the illustrated example, the range is 10% or less. The range (a) corresponds to the range of variation in imbalance rate B(%) in a reliably normal state. An imbalance rate BL (=10(%)) defining the upper limit value of the range (a) is hereinafter referred to as a lower-limit target imbalance rate.

Then, on the characteristic line LXH of the tolerance upper-limit product, the value of the output fluctuation parameter X corresponding to the lower-limit target imbalance rate BL(%) is determined to be the determination value α. The value on the characteristic line LXH of the tolerance upper-limit product is used because the tolerance upper-limit product provides the maximum abnormality-side value of the output fluctuation parameter X.

On the other hand, on the characteristic line LXL of the tolerance lower-limit product, the imbalance rate corresponding to the determination value α is 50(%). In other words, this abnormality detection apparatus fails to accurately detect abnormality unless the actual imbalance rate is higher than 50(%) regardless of the sensor output characteristics. In other words, the abnormality detection apparatus fails to accurately detect abnormality unless the actual imbalance rate B is higher than 50% when the actually installed pre-catalyst sensor 17 is a tolerance lower-limit product. When the pre-catalyst sensor 17 is a tolerance lower-limit product, abnormality can be accurately detected when the level of the imbalance rate is 50(%). Such a range of the imbalance rate that allows abnormality to be accurately detected is denoted by (c). Furthermore, on the characteristic line LXL of the tolerance lower-limit product, an imbalance rate By (=50(%)) corresponding to the determination value α is hereinafter referred to as a lower-limit product detectable imbalance rate.

Within a range (b) between the range (a) and the range (c), abnormality may be detected when the actually installed pre-catalyst sensor 17 is a tolerance upper-limit product.

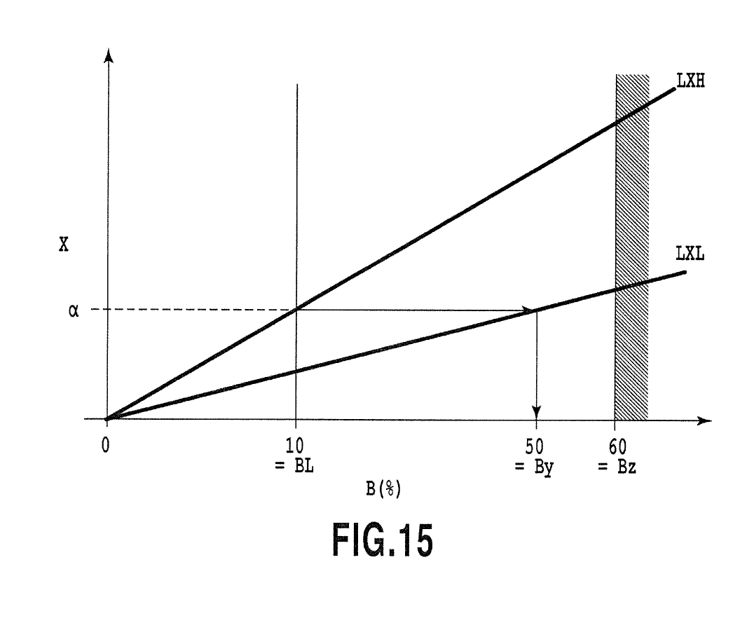

FIG. 15 depicts the comparative example depicted in FIG. 14 in which the detection-needed imbalance rate Bz(%) is 60%. In this case, the detection-needed imbalance rate Bx(%) is higher than the lower-limit detectable imbalance rate By(%), and thus, the abnormality detection apparatus in the comparative example poses no problem. The system consequently functions properly.

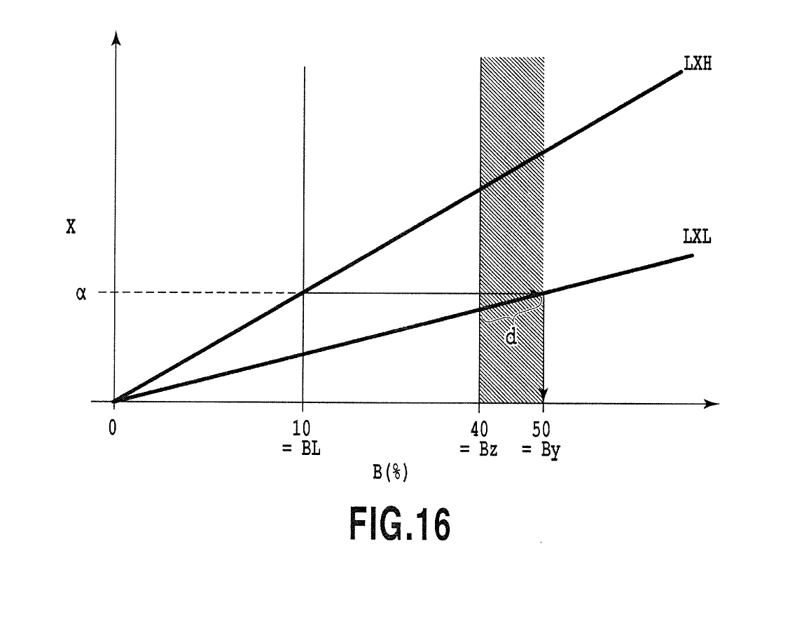

FIG. 16 depicts the comparative example depicted in FIG. 14 in which the detection-needed imbalance rate Bz(%) is 40%. In this case, the detection-needed imbalance rate Bz(%) is lower than the lower-limit product detectable imbalance rate By(%), and thus, the apparatus may fail to accurately detect abnormality when the actually installed pre-catalyst sensor 17 is a tolerance lower-limit product. That is, despite the essential need to detect abnormality within a range (d) from Bz(%) to By(%), the apparatus mistakenly detects normality because the actual value of the output fluctuation parameter X fails to exceed the determination value α. Hence, the abnormality detection apparatus in the comparative example is problematic and the system fails to function properly.

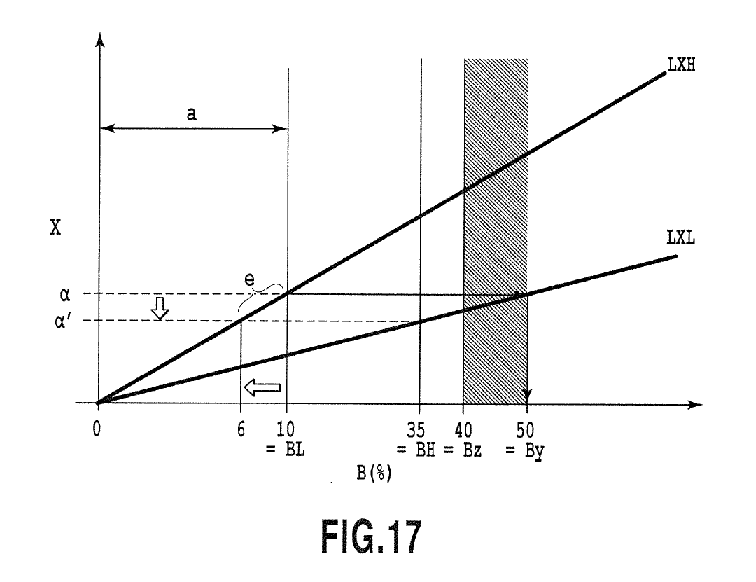

A possible measure against the case in FIG. 16 is as follows. That is, as depicted in FIG. 17, first, an upper-limit target imbalance rate BH(%) is defined which is lower than the detection-needed imbalance rate Bz=40(%) by a predetermined margin. In the illustrated example, this rate is 35(%) and the margin is 5(%).

Then, on the characteristic line LXL of the tolerance upper-limit product, the value of the output fluctuation parameter X corresponding to the upper-limit target imbalance rate BH(%) is determined to be a determination value α′. In other words, the determination value is changed to a smaller value α′ based on the characteristic line LXL of the tolerance lower-limit product. This allows abnormality to be reliably detected before the actual imbalance rate reaches the detection-needed imbalance rate Bz(%) when the actually installed pre-catalyst sensor 17 is a tolerance lower-limit product. Furthermore, such a misdetection as described above can be prevented.

However, in this case, when the actually installed pre-catalyst sensor 17 is a tolerance upper-limit product, abnormality may be detected though the actual imbalance rate is lower than the lower-limit target imbalance rate BL (=10(%)). In the illustrated example, abnormality is detected within a range (e) between 6(%) and 10(%). That is, the lower-limit target imbalance rate BL substantially decreases. Then, abnormality is detected within the range (a) that is essentially inappropriate to determine to be abnormal. This is inconsistent with the above-described assumption.

As described above, when an attempt is made to define a single determination value based on only two characteristic lines, the characteristic line LXH of the tolerance upper-limit product and the characteristic line LXL of the tolerance lower limit product, defining the determination value is difficult if the detection-needed imbalance rate Bz (%) is lower than the lower lower-limit product detectable imbalance rate By(%).

Thus, the present embodiment additionally defines another determination value based on another characteristic line different from the above-described characteristic lines to detect variation abnormality based on these determination values. This enables variation abnormality to be suitably and adequately detected regardless of the sensor output characteristics, particularly even when the actually installed pre-catalyst sensor 17 is a tolerance lower-limit product.

The method for detecting variation abnormality according to the present embodiment will be described below in detail. First, variation abnormality detection is generally performed by the ECU 20 by executing the following steps (A) to (E).

(A) A step of calculating the output fluctuation parameter X.

(B) A step of determining whether or not the calculated output fluctuation parameters X is a value between a predetermined primary-determination upper limit value α1H and a predetermined primary-determination lower limit value α1L.

(C) A step of performing the forced active control to reduce the deviation of the air-fuel ratio in a cylinder having the most significant deviation of the air-fuel ratio (the above-described abnormal cylinder) when the calculated parameter is determined to be a value between the predetermined primary-determination upper limit value α1H and the predetermined primary-determination lower limit value α1L.

(D) A step of calculating the output fluctuation parameter X while the forced active control is in execution; and

(E) A step of comparing the output fluctuation parameter X calculated while the forced active control is in execution with a predetermined secondary determination value α2 to determine whether or not variation abnormality is present.

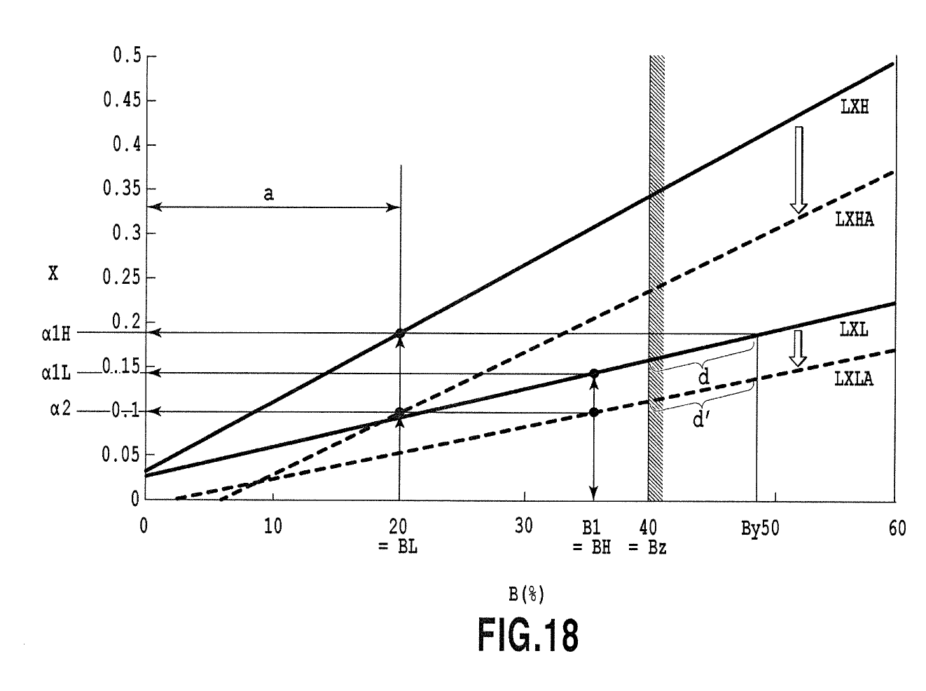

Now, a method for setting the primary-determination upper limit value α1H, the primary-determination lower limit value α1L, and the secondary determination value α2 will be described with reference to FIG. 18. The setting is performed in an adaptation stage, and the set determination values are prestored in the ECU 20.

FIG. 18 depicts characteristics or characteristic lines representing the relation between the imbalance rate B(%) and the output fluctuation parameter X. In particular, the imbalance rate B(%) on the axis of abscissas corresponds to the imbalance rate B(%) obtained in a normal control state, that is, while the stoichiometric control as normal control is in execution, with the forced active control not in execution. When the forced active control is in execution, the forced active control is performed while the stoichiometric control, serving as a base, is in execution.

As described above, LXH denotes a characteristic line obtained when the pre-catalyst sensor 17 is a tolerance upper-limit product, and LXL denotes a characteristic line obtained when the pre-catalyst sensor 17 is a tolerance lower-limit product. Both the characteristic lines are obtained while the forced active control is not in execution.

LXHA denotes a characteristic line obtained when the pre-catalyst sensor 17 is a tolerance upper-limit product and while the forced active control is in execution. Furthermore, LXLA denotes a characteristic line obtained when the pre-catalyst sensor 17 is a tolerance lower-limit product and while the forced active control is in execution. As described below in detail, the characteristic lines in the illustrated example are obtained when the forced active control is performed with a predetermined amount of forced active control Bf.

As seen in FIG. 18, when the forced active control is performed, the characteristic lines LXH and LXL shift toward a decrease side (smaller variation side) of the output fluctuation parameter X. Furthermore, the characteristic difference between the characteristic lines LXH and LXL decreases. This is because the forced active control is such control as reduces the deviation of the air-fuel ratio in one cylinder having the most significant deviation of the air-fuel ratio.

(1) First, as described above, the range (a) of the imbalance rate B(%) is determined which is inappropriate to determine to be abnormal (the range to be prevented from being determined to be abnormal) regardless of the sensor output characteristics. In the illustrated example, the range is 20% or less. That is, the imbalance rate BL defining the upper limit value of the range (a) is 20(%).

(2) Then, on the characteristic line LXH of the tolerance upper-limit product, the value of the output fluctuation parameter X corresponding to the lower-limit target imbalance rate BL(%) is determined to be the primary determination upper-limit value α1H. In the illustrated example, α1H=about 0.19.

(3) Then, on the characteristic line LXHA obtained when the pre-catalyst sensor 17 is a tolerance upper-limit product and while the forced active control is in execution, the output fluctuation parameter X corresponding to the lower-limit target imbalance rate BL(%) is determined to be the secondary determination value α2. In the illustrated example, α2=about 0.1.

(4) Then, on the characteristic line LXLA obtained when the pre-catalyst sensor 17 is a tolerance lower-limit product and while the forced active control is in execution, the value of the imbalance rate B1(%) corresponding to the secondary determination value α2 is determined. Then, whether or not the value B1(%) is equal to or less than the detection-needed imbalance rate Bz(%) is checked. In the illustrated example, B1=about 35(%) and Bz=40(%), and thus, B1(%) is smaller than Bz(%). Hence, the B1(%) is determined to be the upper-limit target imbalance rate BH(%).

(5) Finally, on the characteristic line LXL for a tolerance upper-limit product, the output fluctuation parameter X corresponding to the upper-limit target imbalance rate BH(%) is determined to be the primary determination lower-limit value α1L. In the illustrated example, α1L=about 0.14.

In the illustrated example, the detection-needed imbalance rate Bz (=40%) is lower than the lower-limit product detectable imbalance rate By (=about 48%). Thus, when using only the primary determination upper-limit value α1H, the apparatus mistakenly detects abnormality within the range (d) when the tolerance lower-limit product is actually installed, as described above.

However, the present embodiment first determines whether or not the actually calculated output fluctuation parameter X has a value between the primary determination upper-limit value α1H and the primary determination lower-limit value α1L, that is, whether or not the parameter is in a gray zone in which the apparatus may mistakenly detect normality when the tolerance lower-limit product is actually installed. If the result of the determination is affirmative, the forced active control is performed, and the output fluctuation parameter X calculated while the forced active control is in execution is compared with the secondary determination value α2 to allow determination of whether or not variation abnormality is present. In other words, if the actually calculated output fluctuation parameter X is in the gray zone, the forced active control is performed to change the characteristic line to the characteristic line LXHA or LXLA, which has a smaller characteristic difference. Then, with the upper-limit target imbalance rate BH set lower than the detection-needed imbalance rate Bz(%), whether or not variation abnormality is present is determined.

As a result, the execution of the forced active control shifts the value in the range (d) to a value in a range d′. The value in the range d′ is larger than the secondary determination value α2, allowing the determination of the presence of abnormality. This avoids misdetection to allow variation abnormality to be suitably and adequately detected even when the actually installed pre-catalyst sensor 17 is a tolerance lower-limit product.

Furthermore, the present embodiment allows the suitable and adequate detection, in the normal control state, of variation abnormality within the range of BH to Bz, which is lower than the range of Bz to By. This sufficiently meets the legal requirement that abnormality be inevitably detected when the actual imbalance rate B(%) exceeds the detection-needed imbalance rate Bz(%).

The reason why whether or not the B1(%) is equal to or lower than the detection-needed imbalance rate Bz(%) is as follows. The characteristic lines LXHA and LXLA, obtained while the forced active control is in execution, change depending on what amount of forced active control is performed, in other words, to what value the forced active control is set. Hence, in some cases, the B1(%) is higher than the detection-needed imbalance rate Bz(%). However, this precludes the system from functioning properly. Thus, the B1(%) is determined to be the upper-limit target imbalance rate BH(%) only when the B1(%) is equal to or lower than the detection-needed imbalance rate Bz(%). If, in contrast, the B1(%) is higher than the detection-needed imbalance rate Bz(%), an adaptation operation such as a change in the amount of forced active control is performed again.

In this case, the upper-limit target imbalance rate BH(%) is set to have a smaller value than the detection-needed imbalance rate Bz(%). However, the upper-limit target imbalance rate BH(%) may be set to have a value equal to the value of the detection-needed imbalance rate Bz(%).

The output fluctuation parameter X may be referred to as “primary parameter”. The imbalance rate B(%) may be referred to as “secondary parameter”. The characteristic line LXLA may be referred to as the “first characteristic line”. The upper-limit target imbalance rate BH(%) may be referred to as the “upper-limit target value of the secondary parameter”. The characteristic line LXL may be referred to as the “second characteristic line”. The characteristic line LXH may be referred to as the “third characteristic line”. The lower-limit target imbalance rate BL(%) may be referred to as the “lower-limit target value of the secondary parameter”.

Now, the forced active control will be described. The forced active control is such control as reduces the deviation of the air-fuel ratio in one cylinder having the most significant deviation of the air-fuel ratio, that is, what is called reverse active control.

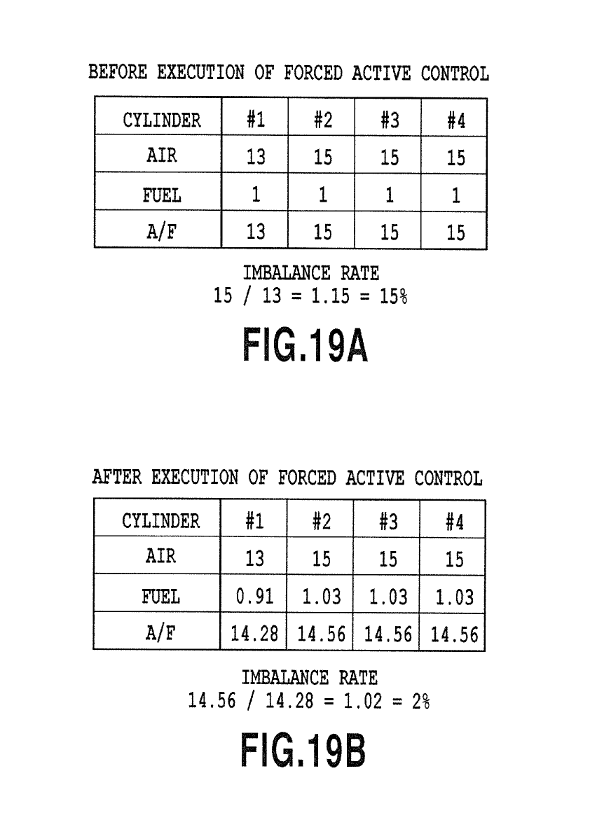

FIGS. 19A and 19B are tables for comparison of the imbalance rates obtained before the forced active control is performed (before execution) and after the forced active control is performed (after execution). Here, all the values of the amount of fuel and the air-fuel ratio depicted in (A) and (B) are obtained after the air-fuel ratio of the total gas converges to the stoichiometric value (14.5) as a result of the stoichiometric control.

FIG. 19A depicts a state where imbalance is present in the normal control state and where the forced control active control has not been performed yet. As is apparent from FIG. 19A, the amount of fuel is 1 in all the cylinders, but the amount of air varies due to the abnormality of a pneumatic system for the #1 cylinder; the amount of air is 13 only in the #1 cylinder and 15 in the other cylinders. Hence, the imbalance rate is 15/13=1.15=15%. The #1 cylinder has a rich-side deviation of the air-fuel ratio.

This state may occur when, for example, a cylinder intake passage (branch pipe 4 or intake port) in the #1 cylinder is blocked by deposits or the like or the intake valve is inappropriately opened.

FIG. 19B depicts a state resulting from execution of the forced control active control in the state in FIG. 19A. In this case, for a reduction in the rich-side deviation in the #1 cylinder, the amount of fuel only in the #1 cylinder is forcibly decreased. As a result of such reduction and the stoichiometric control, the amount of fuel is 0.91 only in the #1 cylinder and 1.03 in the other cylinders. The air-fuel ratio is 14.28 only in the #1 cylinder and 14.56 in the other cylinders. Hence, the imbalance rate is 14.56/14.28=1.02=2%.

For the amount of fuel, the imbalance rate for the amount of fuel is 1.03/0.91=1.13=13%. In contrast, in the state where the forced control active control has not been performed yet as depicted in FIG. 11(A), the imbalance rate of the amount of fuel is 1/1=1=0%. This means that the execution of the forced control active control has forcibly reduced the amount of fuel in the #1 cylinder having a rich-side deviation, by 13% in terms of the imbalance rate for the amount of fuel.

Thus, the imbalance rate for the amount of fuel=13% is considered to be the amount of reduction in the deviation of the air-fuel ratio achieved by the forced control active control according to the present embodiment, that is, the amount of forced active control Bf. In other words, if anyone cylinder has a rich-side deviation, the amount of fuel is forcibly reduced only in the cylinder by a value equivalent to the imbalance rate for the amount of fuel, 13%. The value of 13% is illustrative and can be appropriately changed.

The amount of forced control active control Bf as described above is prestored in the ECU 20 as a constant value. Furthermore, the characteristic lines LXHA and LXLA, depicted in FIG. 18 and obtained while the forced control active control is in execution, result from the execution of the forced control active control with the same amount of forced control active control Bf.

The execution of the forced control active control needs identification of one of all the cylinders that has the most significant deviation of the air-fuel ratio, that is, an abnormal cylinder. Thus, the abnormal-cylinder identification process and method according to the present embodiment as described above are suitably used.

Now, a variation abnormality detection process according to the present embodiment will be described. The detection process is executed by the ECU 20 in accordance with such an algorithm as illustrated in a flowchart in FIG. 20.

First, in step S201, the ECU 20 determines whether a predetermined prerequisite suitable for execution of variation abnormality detection is established. For example, the prerequisite is established when the following conditions are established.

(1) Warm-up of the engine is complete.

(2) The pre-catalyst sensor 17 and the post-catalyst sensor 18 have been activated.

(3) The upstream catalyst 11 and the downstream catalyst have been activated.

(4) The number of rotations Ne of the engine and a load KL on the engine fall within the respective predetermined ranges. For example, the number of rotations Ne is between 1,200 (rpm) and 2,000 (rpm), and the load KL is between 40(%) and 60(%).

(5) The stoichiometric control is in execution.

Another example of the prerequisite may be specified. For example, the condition that (6) the engine is operating steadily may be added.

If the prerequisite is not established, the ECU 20 waits. When the prerequisite is established, the ECU 20 proceeds to step S202. In this case, steps subsequent to step S202 are assumed to be executed only when the prerequisite is established.

In step S202, the output fluctuation parameter X1 is calculated which is obtained in the normal control state where the forced active control is not in execution. A method for the calculation in this case is similar to the method in step S103 in FIG. 12.

In step S203, the ECU 20 determines whether or not the calculated value of the output fluctuation parameter X1 is between the primary-determination upper limit value α1H and the primary-determination lower limit value α1L, that is, within the range of α1L≦X1α1H. Such determination or judgment is referred to as primary determination.

When the calculated value is within the range of α1L≦X1α1H, any one of the cylinders is expected to have such a relatively slight deviation of the air-fuel ratio as belongs to the above-described gray zone. Thus, in this case, in step S204, the abnormal cylinder is identified which is the target cylinder for the forced active control. At this time, the abnormal-cylinder identification process and method according to the present embodiment as described above is suitably used. The identification of the abnormal cylinder is performed in accordance with such an identification process as depicted in FIG. 12.

Then, in step S205, the forced active control is performed. That is, the amount of fuel injected in the abnormal cylinder is reduced or increased by a predetermined value so as to reduce the deviation of the air-fuel ratio in the abnormal cylinder.

In step S206, the value of the output fluctuation parameter X2 obtained while the forced active control is in execution is calculated. A method for the calculation in this case is also similar to the method in step S103 in FIG. 12.

In step S207, the calculated value of the output fluctuation parameter X2 is compared with the secondary determination value α2 to allow determination of whether the output fluctuation parameter X2 is larger or smaller than the secondary determination value α2. Such determination or judgment is referred to as secondary determination.

If the value of the output fluctuation parameter X2 is equal to or smaller than the secondary determination value, the ECU 20 determines in step S208 that variation abnormality is absent, that is, the cylinder is normal. The abnormal cylinder identified in step S204 is finally determined not to be abnormal.

On the other hand, if the value of the output fluctuation parameter X2 is larger than the secondary determination value, the ECU 20 determines in step S209 that variation abnormality is present, that is, the cylinder is abnormal. The abnormal cylinder identified in step S204 is finally determined to be abnormal. In this case, an alarm apparatus such as a check lamp is activated to inform the user of the abnormality, thus urging the user to make a relevant repair. Furthermore, information on the abnormal cylinder is stored in the ECU 20.

In step S203, if the value of the output fluctuation parameter X1 in the normal control state falls out of the range of α1L<X1≦α1H, the cylinder is expected to be definitely normal or abnormal. Thus, in this case, the value of the output fluctuation parameter X1 is compared with the primary-determination lower limit value α1L in step S210 to allow direct determination of whether the cylinder is normal or abnormal.

That is, if the value of the output fluctuation parameter X1 is equal to or smaller than the primary-determination lower limit value α1L, the ECU 20 determines in step S211 that variation abnormality is absent, that is, the cylinder is normal.

On the other hand, if the value of the output fluctuation parameter X1 is larger than the primary-determination lower limit value α1L, this means that the value of the output fluctuation parameter X1 is larger than the primary-determination upper limit value α1H. In step S212, the ECU 20 thus determines that variation abnormality is present, that is, the cylinder is abnormal. In this case, any one of the cylinders is expected to have a relatively significant deviation of the air-fuel ratio.

Possible methods for directly determining whether the cylinder is normal or abnormal include not only comparison only with the primary-determination lower limit value α1L as described above but also comparison only with the primary-determination upper limit value α1H and comparison both with the primary-determination lower limit value α1L and with the primary-determination upper limit value α1H.

As described above, the ECU 20 also executes the following step (F).

(F) A step of comparing the output fluctuation parameter X1 with at least one of the primary-determination upper and lower limit values α1H and an to determine whether or not the variation abnormality is present when the ECU 20 determines in step (B) that the output fluctuation parameter X1 is not a value between the primary-determination upper limit value α1H and the primary-determination lower limit value α1L.

The preferred embodiment of the present invention has been described in detail. However, various other embodiments are possible for the present invention. For example, the above-described numerical values are illustrative and may be variously changed. Furthermore, if only one of the rich and lean sides is described in any portion of the above description, it should be easily understood by those skilled in the art that the description of that side is applicable to the other side.

When two estimated abnormal cylinders are identified from the sensor output waveform, the identification need not necessarily be based on the two peak phases θpL and θpR. Various other identification methods are possible. When similar processing is executed on the lean side and on the rich side, the order of processing is optional.

The embodiment of the present invention is not limited to the above-described embodiment. The present invention includes any variations, applications, and equivalents embraced by the concepts of the present invention defined by the claims. Thus, the present invention should not be interpreted in a limited manner but is applicable to any other technique belonging to the scope of the concepts of the present invention.

1. An inter-cylinder air-fuel ratio variation abnormality detection apparatus comprising:
an air-fuel ratio sensor installed in an exhaust passage common to a plurality of cylinders in a multicylinder internal combustion engine; and
a control apparatus configured to calculate a parameter correlated with a degree of a fluctuation in an output from the air-fuel ratio sensor to detect inter-cylinder air-fuel ratio variation abnormality based on the calculated parameter,
wherein the control apparatus is configured to execute:
(A) a step of identifying two cylinders estimated to have a deviation of an air-fuel ratio based on an output waveform from the air-fuel ratio sensor during one cycle of the internal combustion engine;
(B) a step of performing reducing control to reduce the deviation of the air-fuel ratio in a first cylinder of the two cylinders;
(C) a step of calculating a first value of the parameter corresponding to the first cylinder while the reducing control in the step (B) is in execution;
(D) a step of performing reducing control to reduce the deviation of the air-fuel ratio in a second cylinder of the two cylinders;
(E) a step of calculating a second value of the parameter corresponding to the second cylinder while the reducing control in the step (D) is in execution; and
(F) a step of identifying one of the two cylinders having a most significant deviation of the air-fuel ratio based on the first and second values.

2. The inter-cylinder air-fuel ratio variation abnormality detection apparatus according to claim 1, wherein, in the step (F), the control apparatus identifies the cylinder corresponding to one of the first and second values having a larger value on a normal side, as the one of the cylinders.

3. The inter-cylinder air-fuel ratio variation abnormality detection apparatus according to claim 1, wherein one of the two cylinders is a cylinder estimated to have one of a lean- and a rich-side deviations in the air-fuel ratio, and the other cylinder is a cylinder estimated to have the other of the lean- and rich-side deviations in the air-fuel ratio.

4. The inter-cylinder air-fuel ratio variation abnormality detection apparatus according to claim 3, wherein, in the step (F), the control apparatus identifies the cylinder corresponding to one of the first and second values having a larger value on the normal side, as the one of the cylinders having a largest lean- or rich-side deviation of the air-fuel ratio.

5. The inter-cylinder air-fuel ratio variation abnormality detection apparatus according to claim 1, wherein the first cylinder and the second cylinder are opposite cylinders spaced at a combustion interval equal to a half cycle of the internal combustion engine.

6. The inter-cylinder air-fuel ratio variation abnormality detection apparatus according to claim 1, wherein the output waveform from the air-fuel ratio sensor is a periodic waveform with a period equal to one cycle of the internal combustion engine.

7. The inter-cylinder air-fuel ratio variation abnormality detection apparatus according to claim 1, wherein, in the step (A), the control apparatus identifies the two cylinders based on a lean-side peak phase and a rich-side peak phase of the output waveform from the air-fuel ratio sensor.

8. The inter-cylinder air-fuel ratio variation abnormality detection apparatus according to claim 7, wherein, in the step (A), the control apparatus identifies a source cylinder for exhaust gas detected by the air-fuel ratio sensor at a point in time of the lean-side peak phase, as a cylinder estimated to have a lean-side deviation of the air-fuel ratio, and identifies a source cylinder for exhaust gas detected by the air-fuel ratio sensor at a point in time of the rich-side peak phase, as a cylinder estimated to have a rich-side deviation of the air-fuel ratio.

9. The inter-cylinder air-fuel ratio variation abnormality detection apparatus according to claim 1, wherein the control apparatus is configured to execute, when detecting variation abnormality:
(G) a step of calculating the parameter;
(H) a step of determining whether or not the calculated parameter is a value between a predetermined primary-determination upper limit value and a predetermined primary-determination lower limit value;
(I) a step of performing reducing control to reduce the deviation of the air-fuel ratio in one cylinder having a most significant deviation of the air-fuel ratio when the calculated parameter is determined to be a value between the predetermined primary-determination upper limit value and the predetermined primary-determination lower limit value;
(J) a step of calculating the parameter while the reducing control is in execution; and
(K) a step of comparing the parameter calculated while the reducing control is in execution with a predetermined secondary determination value to determine whether or not variation abnormality is present,
wherein the control apparatus executes the steps (A) to (F) when
identifying the one cylinder having the most significant deviation of the air-fuel ratio in the step (I).
